(19) United States
(12) Patent Application Publication
(10) Pub. No.: US 2026/0252653 A1
(43) Pub. Date: Aug. 27, 2026

(54) SYSTEM

(71) Applicant: SoftBank Group Corp., Tokyo (JP)

(72) Inventor: Takehiro AOSHIMA, Tokyo (JP)

(73) Assignee: SoftBank Group Corp., Tokyo (JP)

(21) Appl. No.: 19/539,045

(22) Filed: Feb. 13, 2026

(30) Foreign Application Priority Data
Feb. 21, 2025 (JP) 2025-027043

(51) Int. Cl. G06F 16/9535; G06F 40/30; G06N 3/08

(52) U.S. Cl. CPC G06F 16/9535; G06F 40/30; G06N 3/08

(57) ABSTRACT

The system according to the embodiment comprises an input unit, a detection unit, a correction unit, and an addition unit. The input unit inputs each data in a dataset. The detection unit analyzes the data input by the input unit and detects inappropriate expressions. The correction unit corrects the inappropriate expressions detected by the detection unit to appropriate expressions. The addition unit adds the data corrected by the correction unit to the original dataset.

### CROSS-REFERENCE TO RELATED APPLICATION

The present application claims priority to and incorporates by reference the entire contents of Japanese Patent Application No. 2025-027043 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to efficiently correct inappropriate expressions in a dataset and maintain high-quality data.

### SUMMARY OF THE INVENTION

The system according to the embodiment comprises an input unit, a detection unit, a correction unit, and an addition unit. The input unit inputs each data in a dataset. The detection unit analyzes the data input by the input unit and detects inappropriate expressions. The correction unit corrects the inappropriate expressions detected by the detection unit to appropriate expressions. The addition unit adds the data corrected by the correction unit to the original dataset.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### [First Embodiment]

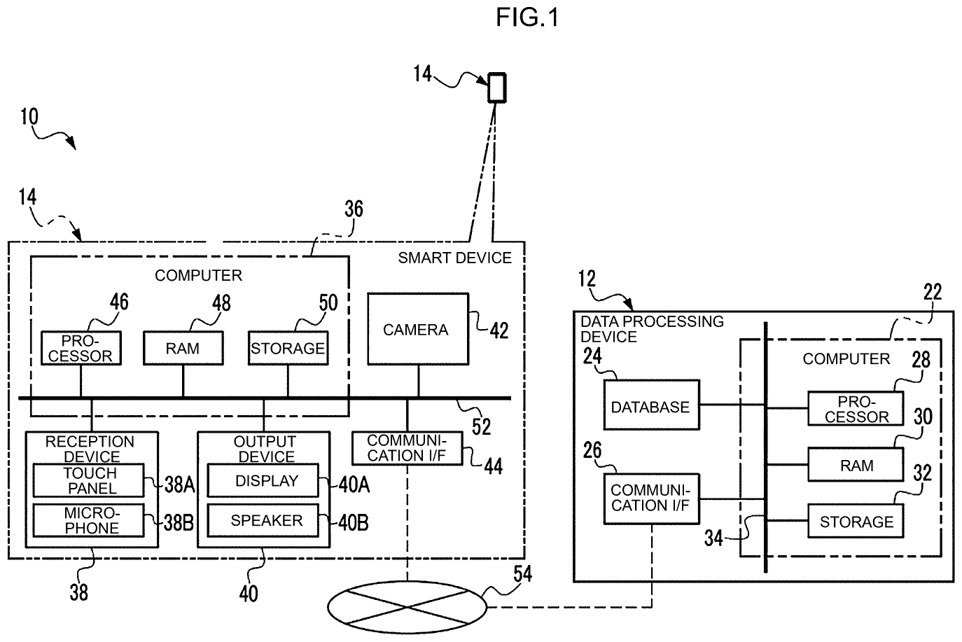

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

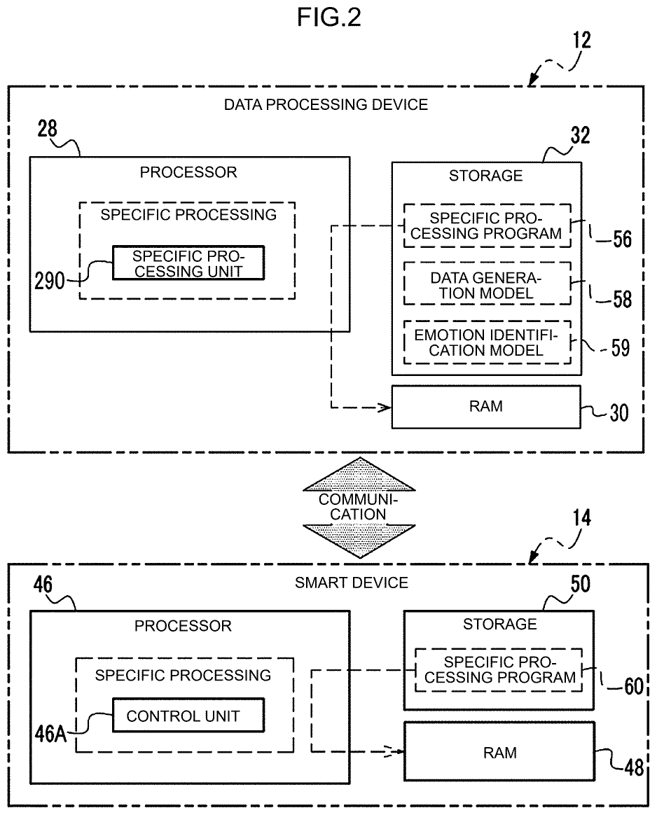

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The dataset correction system according to the embodiment of the present invention is a system that automatically corrects inappropriate expressions in a dataset using generative AI, thereby improving the quality of the data. This dataset correction system inputs each data in the dataset into generative AI, which analyzes each data to detect inappropriate expressions and corrects them to appropriate expressions, thus constructing a high-quality dataset without reducing the number of data. For example, the dataset may include questions and answers posted by users, and by inputting these data into generative AI, the generative AI becomes ready to analyze the data. Next, the generative AI analyzes the input data and detects inappropriate expressions. The generative AI uses a pre-trained model to identify inappropriate expressions in the data. For example, discriminatory expressions and offensive words are detected as inappropriate expressions. At this time, the generative AI is required to detect inappropriate expressions with high accuracy. For the detected inappropriate expressions, the generative AI corrects them to appropriate expressions. The generative AI performs corrections to replace the detected inappropriate expressions with appropriate expressions. For example, discriminatory expressions are corrected to neutral expressions, and offensive words are replaced with milder words. This correction improves the quality of the data. The corrected data is added to the original dataset. As a result, a high-quality dataset is constructed without reducing the number of data. For example, by retaining both the data before correction and the data after correction, it is possible to maintain the number of data while improving quality. In this way, inappropriate expressions in the dataset can be efficiently corrected, and a dataset suitable for training generative AI can be provided. For example, by improving the quality of the dataset used for training generative AI, the performance of the generative AI is also expected to improve. Thus, the dataset correction system can efficiently correct inappropriate expressions in the dataset and construct a high-quality dataset. Specifically, this dataset correction system is composed of multiple modules such as an input unit, a detection unit, a correction unit, and an addition unit. The input unit receives each data in the dataset (e.g., user-posted questions, answers, review comments, and other text data) sequentially or in batch format, performs natural language processing such as tokenization, normalization, and removal of unnecessary words as preprocessing, and formats the data as input tensors for generative AI (e.g., token ID sequences, integer arrays of maximum length 512 to 2048 tokens). Examples of input include offensive or negative sentences such as “This product is totally useless, can't be used,” “Your opinion is wrong,” or sentences containing discriminatory expressions such as “People of XX are . . . ”. The detection unit uses a pre-trained large language model (for example, a Transformer-based autoregressive model or encoder-decoder model) to map the input text data into a high-dimensional vector space via multi-layer self-attention mechanisms and determines the presence or absence of inappropriate expressions at the token or sentence level. The determination may be obtained as a binary label (“inappropriate/appropriate”) or as a probability distribution (softmax output) such as “offensive: 0.85, discriminatory: 0.10, appropriate: 0.05”. Examples of output include scores such as “offensive: 0.92” or “discriminatory: 0.78”. The detection unit determines an expression as inappropriate if these scores exceed a predetermined threshold (e.g., 0.7) and passes the token indices and contextual information of the relevant portions to the correction unit. The correction unit uses the decoder of the generative AI to automatically replace the detected inappropriate expressions with “neutral expressions” or “mild expressions”. Correction algorithms may include partial generation (infill) that regenerates only the relevant part while maintaining context, or rewrite generation that regenerates the entire sentence. Examples of correction include converting “This product is totally useless, can't be used” to “This product did not meet expectations” or “Your opinion has different perspectives”. The corrected data is added to the original dataset as a new record by the addition unit and managed as paired data before and after correction. The addition unit attaches correction history and metadata (correction date, reason for correction, detection score, etc.) in the database and utilizes them for subsequent selection of training data and quality management. As a technical effect, this system achieves significant improvement in processing speed and accuracy based on consistent criteria compared to manual visual checks and manual corrections, enabling large-scale data expansion and cleansing while maintaining dataset quality. Furthermore, the detection and correction algorithms realize context-dependent judgments that are difficult with rule-based approaches by extracting features in high-dimensional vector spaces, adopting computer-specific non-idiomatic processing methods that differ from conventional simple NG word replacement or human intuitive judgment. Application fields include construction of training datasets for natural language processing, monitoring of SNS posts, automatic FAQ generation, preparation of training data for customer support chatbots, and quality management of educational content. In these fields, the present invention demonstrates remarkable technical effects such as homogenization and improvement of data quality, reduction of AI model bias, suppression of false detection and correction, and reduction of operational costs.

The dataset correction system according to the embodiment comprises an input unit, a detection unit, a correction unit, and an addition unit. The input unit inputs each data in the dataset. The dataset may include, for example, questions and answers posted by users, but is not limited to such examples. The input unit, for example, inputs each data in the dataset into generative AI. The generative AI becomes ready to analyze the data. The detection unit analyzes the data input by the input unit using generative AI and detects inappropriate expressions. The generative AI uses a pre-trained model to identify inappropriate expressions in the data. For example, discriminatory expressions and offensive words are detected as inappropriate expressions. The generative AI is required to detect inappropriate expressions with high accuracy. The correction unit uses generative AI to correct the inappropriate expressions detected by the detection unit to appropriate expressions. The generative AI performs corrections to replace the detected inappropriate expressions with appropriate expressions. For example, discriminatory expressions are corrected to neutral expressions, and offensive words are replaced with milder words. This improves the quality of the data. The addition unit adds the data corrected by the correction unit to the original dataset. As a result, a high-quality dataset is constructed without reducing the number of data. For example, by retaining both the data before correction and the data after correction, it is possible to maintain the number of data while improving quality. Thus, the dataset correction system according to the embodiment can efficiently correct inappropriate expressions in the dataset and construct a high-quality dataset. The generative AI may be a text generative AI (e.g., LLM) or a multimodal generative AI, but is not limited to such examples. The generative AI can perform each process of data analysis, correction, and addition. Thus, the dataset correction system can efficiently correct inappropriate expressions in the dataset and construct a high-quality dataset. Specifically, this dataset correction system receives each data in the dataset (e.g., text, images, audio, etc.) via the input unit, performs preprocessing for natural language processing (tokenization, normalization, stop word removal, etc.), and formats the data as input tensors for generative AI (e.g., token ID sequences for text, pixel value arrays for images, spectrogram arrays for audio, etc.). Examples of input include offensive or discriminatory sentences such as “Your opinion is completely useless,” “People of XX are . . . ,” or inappropriate text embedded in image data. The detection unit uses large language models or multimodal models based on Transformer architecture to convert input data into high-dimensional feature vectors via multi-layer self-attention mechanisms and determines the presence or absence of inappropriate expressions at the token or sentence level. The determination results are output as binary labels (inappropriate/appropriate), multi-class classification (offensive, discriminatory, appropriate, etc.), or probability distributions (e.g., offensive 0.85, discriminatory 0.10, appropriate 0.05). The detection unit determines an expression as inappropriate if these output values exceed a predetermined threshold and passes the index and contextual information of the relevant portions to the correction unit. The correction unit uses algorithms such as partial generation (infill) or full rewrite generation to automatically replace only the relevant part with neutral or mild expressions while maintaining context. Examples of correction include converting “Your opinion is completely useless” to “Your opinion has different perspectives”. The corrected data is added to the original dataset as a new record by the addition unit and managed as paired data before and after correction. The addition unit attaches correction history and metadata (correction date, reason for correction, detection score, etc.) in the database and utilizes them for subsequent selection of training data and quality management. As a technical effect, this system achieves significant improvement in processing speed and accuracy based on consistent criteria compared to manual visual checks and manual corrections, enabling large-scale data expansion and cleansing while maintaining dataset quality. Furthermore, the detection and correction algorithms realize context-dependent judgments that are difficult with rule-based approaches by extracting features in high-dimensional vector spaces, adopting computer-specific non-idiomatic processing methods that differ from conventional simple NG word replacement or human intuitive judgment. Application fields include construction of training datasets for natural language processing, monitoring of SNS posts, automatic FAQ generation, preparation of training data for customer support chatbots, and quality management of educational content. In these fields, the present invention demonstrates remarkable technical effects such as homogenization and improvement of data quality, reduction of AI model bias, suppression of false detection and correction, and reduction of operational costs.

The detection unit can detect discriminatory expressions or offensive words as inappropriate expressions. The detection unit uses generative AI to detect discriminatory expressions or offensive words as inappropriate expressions. The generative AI uses a pre-trained model to identify discriminatory expressions or offensive words in the data. For example, discriminatory expressions may include racial discrimination and gender discrimination. Offensive words may include insulting words and violent words. The generative AI is required to detect these inappropriate expressions with high accuracy. Thus, discriminatory expressions and offensive words can be detected with high accuracy. Some or all of the above-described processing in the detection unit may be performed using generative AI or without using generative AI. For example, the detection unit may input data into generative AI, and the generative AI detects inappropriate expressions. Specifically, the detection unit receives text data (e.g., “People of XX are . . . ”, “You are useless”), applies preprocessing such as tokenization and normalization, and supplies it to the model as an input tensor for generative AI (e.g., token ID sequence, maximum length 2048 tokens). The generative AI uses a Transformer-based multi-layer neural network, extracts contextual information via self-attention mechanisms, and determines the presence or absence of inappropriate expressions at the token or sentence level. The determination is output as a binary label (“inappropriate/appropriate”) or as a probability distribution such as “offensive: 0.92, discriminatory: 0.81, appropriate: 0.07”. Examples of input include “You are completely useless” and “People of XX are . . . ”, and examples of output include scores such as “offensive: 0.95” and “discriminatory: 0.88”. The detection unit determines an expression as inappropriate if these scores exceed a predetermined threshold (e.g., 0.7) and passes the index and contextual information of the relevant portions to the correction unit. The detection unit does not use simple rule-based NG word replacement, but performs feature extraction in high-dimensional vector spaces and context-dependent judgment, thereby realizing computer-specific non-idiomatic processing methods that differ from conventional human work or simple dictionary matching. As a technical effect, the detection unit achieves significant improvement in processing speed and accuracy based on consistent criteria compared to manual visual checks, enabling large-scale data cleansing while maintaining dataset quality. Application fields include monitoring of SNS posts, automatic FAQ generation, and quality management of educational content.

The correction unit can correct discriminatory expressions to neutral expressions. The correction unit uses generative AI to correct discriminatory expressions to neutral expressions. The generative AI performs corrections to replace detected discriminatory expressions with appropriate expressions. For example, discriminatory expressions such as racially discriminatory words are corrected to neutral words. The generative AI is required to perform these corrections with high accuracy. Thus, by correcting discriminatory expressions to neutral expressions, the quality of the data can be improved. Some or all of the above-described processing in the correction unit may be performed using generative AI or without using generative AI. For example, the correction unit may input discriminatory expressions into generative AI, and the generative AI corrects them to neutral expressions. Specifically, the correction unit inputs text data containing discriminatory expressions (e.g., “People of XX are . . . ”) received from the detection unit into the decoder of generative AI and uses algorithms such as partial generation (infill) or full rewrite generation to automatically replace only the relevant part with neutral expressions while maintaining context. Examples of input include converting “People of XX cannot work” to “Some individuals may have difficulty with work”. The generative AI uses a multi-layer neural network with Transformer architecture, extracts contextual information via self-attention mechanisms, generates multiple correction candidates, and selects the most natural expression. Examples of output include “Some individuals may have difficulties” and “People have strengths and weaknesses”. The correction unit automatically selects the candidate most suitable for the context and outputs it as corrected data. The correction algorithm uses generative methods dependent on context rather than simple NG word replacement, thereby realizing computer-specific non-idiomatic processing methods that differ from conventional human work or dictionary-based correction. As a technical effect, the correction unit achieves significant improvement in processing speed and accuracy based on consistent correction criteria compared to manual correction, enabling large-scale data cleansing while maintaining dataset quality. Application fields include construction of training datasets for natural language processing, monitoring of SNS posts, and quality management of educational content.

The correction unit can correct offensive words to milder words. The correction unit uses generative AI to correct offensive words to milder words. The generative AI performs corrections to replace detected offensive words with appropriate words. For example, offensive words such as insulting words are corrected to milder words. The generative AI is required to perform these corrections with high accuracy. Thus, by correcting offensive words to milder words, the quality of the data can be improved. Some or all of the above-described processing in the correction unit may be performed using generative AI or without using generative AI. For example, the correction unit may input offensive words into generative AI, and the generative AI corrects them to milder words. Specifically, the correction unit inputs text data containing offensive words (e.g., “You are useless”, “Totally useless”) received from the detection unit into the decoder of generative AI and uses algorithms such as partial generation or full rewrite generation to automatically replace only the relevant part with milder expressions while maintaining context. Examples of input include converting “You are useless” to “You have different strengths” or “Totally useless” to “Did not meet expectations”. The generative AI uses a multi-layer neural network with Transformer architecture, extracts contextual information via self-attention mechanisms, generates multiple correction candidates, and selects the most natural expression. Examples of output include “You have other qualities” and “People have strengths and weaknesses”. The correction unit automatically selects the candidate most suitable for the context and outputs it as corrected data. The correction algorithm uses generative methods dependent on context rather than simple NG word replacement, thereby realizing computer-specific non-idiomatic processing methods that differ from conventional human work or dictionary-based correction. As a technical effect, the correction unit achieves significant improvement in processing speed and accuracy based on consistent correction criteria compared to manual correction, enabling large-scale data cleansing while maintaining dataset quality. Application fields include monitoring of SNS posts, automatic FAQ generation, and quality management of educational content.

The addition unit can retain both the data before correction and the data after correction. The addition unit uses generative AI to retain both the data before correction and the data after correction. The generative AI performs processing to appropriately manage the data before and after correction. For example, the original text data is retained as the data before correction, and the corrected text data is retained as the data after correction. As a result, a high-quality dataset can be constructed without reducing the number of data. Some or all of the above-described processing in the addition unit may be performed using generative AI or without using generative AI. For example, the addition unit may input both the data before correction and the data after correction into generative AI, and the generative AI retains both data. Specifically, the addition unit records and manages the pair information of the data before and after correction (e.g., original text “You are useless” and corrected text “You have different strengths”) received from the correction unit in a database or storage. The generative AI attaches correction history and metadata (correction date, reason for correction, detection score, etc.) and explicitly retains the correspondence between the data before and after correction in the database. Examples of input include pairs such as before correction “People of XX are . . . ” and after correction “People have strengths and weaknesses”. The addition unit adds these pair data as new records and improves quality while maintaining the number of data. Furthermore, by retaining the data before and after correction, it can be utilized for data augmentation, bias analysis, and evaluation of correction algorithms during subsequent AI model training. The addition unit realizes computer-specific non-idiomatic processing methods for systematic management of correction history and metadata, which differ from conventional human work or simple data replacement. As a technical effect, the addition unit enables large-scale data expansion and cleansing while maintaining dataset quality, contributing to improved learning efficiency and accuracy of AI models and reduction of bias. Application fields include construction of training datasets for natural language processing, monitoring of SNS posts, and quality management of educational content.

The input unit can estimate a user's emotion and adjust the timing of data input based on the estimated user's emotion. The input unit uses generative AI to estimate a user's emotion and adjust the timing of data input based on the estimated user's emotion. The generative AI performs processing to estimate the user's emotion. For example, if the user is feeling stressed, the timing of data input is delayed until the user relaxes. If the user is relaxed, the timing of data input is accelerated for efficient data input. If the user is in a hurry, the timing of data input is optimized for rapid data input. Thus, by adjusting the timing of data input according to the user's emotion, data can be input efficiently. Emotion estimation is realized using, for example, an emotion engine or generative AI with emotion estimation functions. The generative AI may be a text generative AI (e.g., LLM) or a multimodal generative AI, but is not limited to such examples. Some or all of the above-described processing in the input unit may be performed using generative AI or without using generative AI. For example, the input unit may input the user's emotion data into generative AI, and the generative AI adjusts the timing of data input. Specifically, the input unit collects various types of multimodal data such as user input text, audio data, facial images, and operation logs to estimate the user's emotional state, performs preprocessing (e.g., tokenization of text, spectrogram conversion of audio, facial feature extraction from images, time-series vectorization of operation logs), and integrates them as input tensors for generative AI. Examples of input include text such as “I'm tired today,” “I'm in a hurry,” high-pitched audio waveforms, images of smiling or frowning faces, and operation patterns such as rapid tapping or long presses. The generative AI uses a Transformer-based multimodal neural network to integrate feature vectors of each modality via self-attention mechanisms and outputs multiple emotion labels such as “stress,” “relaxation,” “tension,” “impatience,” or probability distributions (e.g., stress 0.82, relaxation 0.10, impatience 0.08). Examples of output include “stress: 0.85” and “relaxation: 0.12”. The input unit uses these emotion estimation results in the data input timing control module to automatically adjust timing via threshold judgment and branching logic, such as waiting for input if the stress value is 0.7 or higher, immediate input if the relaxation value is 0.5 or higher, or shortening the input interval if the impatience value is high. In subsequent processing, the input timing control result is transmitted to the user interface or batch processing scheduler, and the actual timing of data input is controlled. As a technical effect, the input unit realizes input timing control optimized for the user's state by AI inference integrating high-dimensional features of multiple modalities, which differs from human subjective judgment or manual timing adjustment, thereby fundamentally improving processing efficiency, reducing user stress, and enhancing overall system responsiveness. Application fields include customer support chatbots, educational dialogue systems, medical interview support, stress management applications, and user-adaptive interfaces, contributing to improved user experience quality and operational efficiency in these fields.

The input unit can analyze a user's past posting history at the time of data input and select an optimal input method. The input unit uses generative AI to analyze a user's past posting history at the time of data input and select an optimal input method. The generative AI performs processing to analyze the user's past posting history. For example, the input method frequently used by the user in the past (voice, text, etc.) is preferentially suggested. An input method related to a specific category is suggested based on the user's past posting history. The most efficient input method is selected by analyzing the user's past posting history. Thus, by analyzing the user's past posting history, an optimal input method can be selected. Some or all of the above-described processing in the input unit may be performed using generative AI or without using generative AI. For example, the input unit may input the user's past posting history data into generative AI, and the generative AI selects the optimal input method. Specifically, the input unit extracts multi-dimensional structured data such as posting date and time, posting content, input method used (e.g., voice input, text input, handwriting input, image upload), posting category (e.g., question, answer, review), and device information at the time of posting (e.g., smartphone, PC, tablet) from the user's past posting history database, and formats them as time-series vectors or category embedding vectors for the input tensor of generative AI. Examples of input include history data such as “2024 May 1 10:00 Text Question,” “2024 May 2 12:30 Voice Answer,” “2024 May 3 09:15 Image Review.” The generative AI is equipped with a Transformer-based time-series analysis model and category classification head, extracts frequency distributions of past input methods and usage trends by category via self-attention mechanisms, and outputs scores for each user such as “voice input recommendation 0.75,” “text input recommendation 0.20,” “image input recommendation 0.05.” Examples of output include “voice input: 0.82,” “text input: 0.15.” The input unit automatically selects and suggests the optimal input method on the user interface based on these recommendation scores, and if the user selects it, the selection history is fed back as training data. In subsequent processing, the recommended input method is reflected in dialog boxes, button arrangements, activation of voice recognition modules, etc. As a technical effect, the input unit significantly improves input efficiency and user satisfaction by dynamic recommendation based on AI history analysis, which differs from conventional static input method selection or manual switching by the user, thereby enhancing system adaptability and flexibility. Application fields include automatic FAQ response systems, customer support, educational platforms, medical interview systems, and interfaces for supporting people with disabilities, providing optimal input experiences tailored to user characteristics.

The input unit can perform filtering based on the user's current field of interest at the time of data input. The input unit uses generative AI to perform filtering based on the user's current field of interest at the time of data input. The generative AI performs processing to identify the user's current field of interest. For example, data related to topics the user is currently interested in is preferentially input. Data with high relevance is filtered based on the user's current field of interest. The optimal data is selected by considering the user's current field of interest. Thus, by filtering data based on the user's current field of interest, highly relevant data can be input. Some or all of the above-described processing in the input unit may be performed using generative AI or without using generative AI. For example, the input unit may input the user's current field of interest data into generative AI, and the generative AI performs filtering of the data. Specifically, the input unit collects various behavioral data such as the user's recent browsing history, search queries, click logs, “likes” and comment history on SNS, and survey responses, and formats them as token sequences, category embedding vectors, or time-series tensors for the input tensor of generative AI. Examples of input include topic labels such as “AI technology,” “health management,” “travel,” or history data such as “2024 May 1 Search: Natural Language Processing,” “2024 May 2 Browse: Medical AI.” The generative AI uses a Transformer-based topic classification model and attention mechanism to output multi-class classification (e.g., AI 0.65, health 0.20, travel 0.15) or topic ranking from user behavioral data. Examples of output include “AI: 0.72,” “health: 0.18,” “travel: 0.10.” The input unit calculates relevance scores for candidate data groups obtained from databases or external APIs based on these field of interest scores, and filters only data with a relevance score above a predetermined threshold (e.g., 0.5) as input candidates. In subsequent processing, the filtering results are passed to the user interface or automatic input module, and the optimal data is presented or input to the user. As a technical effect, the input unit realizes data input tailored to the user's current interests by dynamic estimation of the field of interest and relevance calculation in high-dimensional feature space by AI, which differs from conventional static category selection or simple keyword matching, thereby greatly reducing information excess, deficiency, and noise. Application fields include recommendation systems, personalized learning support, news distribution, e-commerce product suggestions, and medical information provision, contributing to improved user experience quality and operational efficiency.

The input unit can estimate a user's emotion and specifically determine the priority of data to be input based on the estimated user's emotion. The input unit uses generative AI to estimate a user's emotion and specifically determine the priority of data to be input based on the estimated user's emotion. The generative AI performs processing to estimate the user's emotion. For example, if the user is feeling stressed, data with low importance is preferentially input. If the user is relaxed, data with high importance is preferentially input. If the user is in a hurry, data requiring rapid processing is preferentially input. Thus, by determining the priority of data to be input according to the user's emotion, data can be input efficiently. Emotion estimation is realized using, for example, an emotion engine or generative AI with emotion estimation functions. The generative AI may be a text generative AI (e.g., LLM) or a multimodal generative AI, but is not limited to such examples. Some or all of the above-described processing in the input unit may be performed using generative AI or without using generative AI. For example, the input unit may input the user's emotion data into generative AI, and the generative AI determines the priority of data. Specifically, the input unit collects multimodal data such as user input text, audio data, facial images, and operation logs to estimate the user's emotional state, performs preprocessing (e.g., tokenization of text, spectrogram conversion of audio, facial feature extraction from images, time-series vectorization of operation logs), and integrates them as input tensors for generative AI. Examples of input include text such as “I'm busy today,” “I'm calm,” low-pitched audio waveforms, images of smiling or expressionless faces, and continuous operation patterns. The generative AI uses a Transformer-based multimodal neural network to integrate feature vectors of each modality and outputs emotion labels such as “stress,” “relaxation,” “impatience,” or probability distributions (e.g., stress 0.70, relaxation 0.20, impatience 0.10). Examples of output include “stress: 0.75,” “relaxation: 0.18.” The input unit uses these emotion estimation results to automatically determine the priority of input candidate data groups (e.g., unanswered questions, notifications, tasks) by combining importance scores or urgency scores with emotion labels. For example, if the stress value is high, data with low importance is input first; if the relaxation value is high, data with high importance is input first; if the impatience value is high, data with high urgency is input first. In subsequent processing, the priority results are reflected in the input queue or user interface, and the actual order of data input is controlled. As a technical effect, the input unit realizes data input optimized for the user's state by dynamic priority control based on multi-dimensional feature analysis by AI, which differs from human subjective judgment or manual priority assignment, thereby fundamentally improving work efficiency, reducing user burden, and enhancing overall system responsiveness. Application fields include customer support, educational dialogue systems, medical interview support, task management, and user-adaptive interfaces, contributing to improved user experience quality and operational efficiency.

The input unit can preferentially input highly relevant data by considering the user's geographic location information at the time of data input. The input unit uses generative AI to preferentially input highly relevant data by considering the user's geographic location information at the time of data input. The generative AI performs processing to consider the user's geographic location information. For example, if the user is in a specific region, data related to that region is preferentially input. Data with high relevance is filtered based on the user's geographic location information. The optimal data is selected based on the user's current location. Thus, by considering the user's geographic location information, highly relevant data can be preferentially input. Some or all of the above-described processing in the input unit may be performed using generative AI or without using generative AI. For example, the input unit may input the user's geographic location information data into generative AI, and the generative AI preferentially inputs highly relevant data. Specifically, the input unit preprocesses geographic location information such as latitude and longitude obtained from the user terminal, location accuracy, duration of stay, and movement history as time-series vectors or category embedding vectors, and formats them as input tensors for generative AI (e.g., float32 latitude/longitude arrays, movement history vectors of time-series length 24). Examples of input include “latitude 35.6895, longitude 139.6917, duration 120 minutes,” “movement history: Tokyo→Yokohama→Kawasaki.” The generative AI is equipped with a Transformer-based geographic information processing module and location embedding layer, integrates geographic features, user profiles, and past behavioral history into a high-dimensional feature space, and calculates relevance scores with candidate data groups (e.g., local event information, nearby store reviews, regional news) (e.g., 0.92, 0.75, 0.10). Examples of output include “local event information: 0.88,” “nearby store reviews: 0.81,” “national news: 0.12.” The input unit preferentially selects only data with relevance scores exceeding a predetermined threshold (e.g., 0.7) as input candidates and presents them to the user interface or automatic input module. In subsequent processing, the preferential input data is displayed on the user screen and linked to batch processing or notification systems. As a technical effect, the input unit realizes information provision optimized for the user's current location and movement trends by dynamic analysis and relevance calculation of geographic location information as high-dimensional features by AI, which differs from conventional static data presentation or simple keyword matching, thereby greatly reducing information excess, deficiency, and noise. Furthermore, by combining geographic features with other user attributes and behavioral history, personalized data input control that is difficult with conventional human work or rule-based processing is enabled, greatly enhancing system adaptability and flexibility. Application fields include region-specific recommendation systems, tourist guide apps, disaster information distribution, regional community SNS, location-based advertising distribution, and regional optimization of medical and welfare services, contributing to improved user experience quality, operational efficiency, and optimization of information distribution in these fields.

The input unit can analyze a user's social media activity at the time of data input and input relevant data. The input unit uses generative AI to analyze a user's social media activity at the time of data input and input relevant data. The generative AI performs processing to analyze the user's social media activity. For example, data related to topics frequently posted by the user on social media is preferentially input. Relevant data is filtered by analyzing the user's social media activity. The optimal data is selected based on the user's social media activity. Thus, by analyzing the user's social media activity, relevant data can be input. Some or all of the above-described processing in the input unit may be performed using generative AI or without using generative AI. For example, the input unit may input the user's social media activity data into generative AI, and the generative AI inputs relevant data. Specifically, the input unit collects multi-dimensional structured data such as the user's SNS posting history, comments, like history, share history, follow relationships, posting time, and posting category (e.g., hobby, work, news), applies preprocessing such as tokenization and embedding vectorization for text data, time-series tensorization for behavioral history, and one-hot vectorization for category information, and integrates them as input tensors for generative AI. Examples of input include “2024 May 1 Post: AI technology,” “2024 May 2 Comment: Health management,” “2024 May 3 Like: Travel.” The generative AI is equipped with a Transformer-based multimodal analysis model and topic classification head, extracts major topics and fields of interest from the user's posting content and behavioral trends, and outputs relevance scores with candidate data groups (e.g., latest AI news, health-related products, travel plans) (e.g., AI 0.82, health 0.10, travel 0.08). Examples of output include “AI-related data: 0.85,” “health-related data: 0.12.” The input unit preferentially selects only data with relevance scores above a predetermined threshold (e.g., 0.7) as input candidates and presents them to the user interface or automatic input module. In subsequent processing, the preferential input data is displayed on the user screen and linked to notification systems or recommendation engines. As a technical effect, the input unit realizes information provision tailored to the user's interests and concerns by dynamic analysis and relevance calculation of high-dimensional features of SNS activity by AI, which differs from conventional static data presentation or simple keyword matching, thereby greatly reducing information excess, deficiency, and noise. Furthermore, by combining SNS activity with other user attributes and behavioral history, personalized data input control that is difficult with conventional human work or rule-based processing is enabled, greatly enhancing system adaptability and flexibility. Application fields include SNS-linked recommendation systems, personalized advertising distribution, user profiling, community management support, customer support automation, and educational content recommendation, contributing to improved user experience quality, operational efficiency, and optimization of information distribution in these fields.

The detection unit can estimate a user's emotion and specifically adjust the detection criteria for inappropriate expressions based on the estimated user's emotion. The detection unit uses generative AI to estimate a user's emotion and specifically adjust the detection criteria for inappropriate expressions based on the estimated user's emotion. The generative AI performs processing to estimate the user's emotion. For example, if the user is feeling stressed, strict detection criteria are applied to rigorously detect inappropriate expressions. If the user is relaxed, flexible detection criteria are applied to detect inappropriate expressions more leniently. If the user is in a hurry, the detection criteria are quickly adjusted to efficiently detect inappropriate expressions. Thus, by adjusting the detection criteria for inappropriate expressions according to the user's emotion, inappropriate expressions can be efficiently detected. Emotion estimation is realized using, for example, an emotion engine or generative AI with emotion estimation functions. The generative AI may be a text generative AI (e.g., LLM) or a multimodal generative AI, but is not limited to such examples. Some or all of the above-described processing in the detection unit may be performed using generative AI or without using generative AI. For example, the detection unit may input the user's emotion data into generative AI, and the generative AI adjusts the detection criteria for inappropriate expressions. Specifically, the detection unit collects multimodal emotion data such as user input text, audio data, facial images, and operation logs, applies preprocessing such as tokenization for text, spectrogram conversion for audio, facial feature extraction for images, and time-series vectorization for operation logs, and integrates them as input tensors for generative AI. Examples of input include text such as “I'm irritated today,” “I'm calm,” images of angry or smiling faces, and sudden operation patterns. The generative AI uses a Transformer-based multimodal emotion estimation model to integrate feature vectors of each modality and outputs emotion labels such as “stress,” “relaxation,” “impatience,” or probability distributions (e.g., stress 0.80, relaxation 0.10, impatience 0.10). Examples of output include “stress: 0.85,” “relaxation: 0.12.” The detection unit uses these emotion estimation results in the detection criteria control module to automatically adjust criteria via threshold judgment and branching logic, such as strict detection threshold (e.g., offensive score 0.5 or higher for inappropriate judgment) if the stress value is 0.7 or higher, relaxed detection threshold (e.g., offensive score 0.8 or higher for inappropriate judgment) if the relaxation value is 0.5 or higher, or prioritizing detection speed if the impatience value is high. In subsequent processing, the adjusted detection criteria are applied to the inappropriate expression detection module and reflected in the actual detection results. As a technical effect, the detection unit realizes inappropriate expression detection optimized for the user's state by dynamic criteria control based on multi-dimensional feature analysis by AI, which differs from human subjective judgment or manual criteria adjustment, thereby fundamentally improving reduction of false detection and oversight, work efficiency, and overall system responsiveness. Application fields include monitoring of SNS posts, educational dialogue systems, customer support, medical interview support, and user-adaptive interfaces, contributing to improved user experience quality and operational efficiency.

The detection unit can improve the detection accuracy of inappropriate expressions by considering the context of the data at the time of detection. The detection unit uses generative AI to improve the detection accuracy of inappropriate expressions by considering the context of the data at the time of detection. The generative AI performs processing to consider the context of the data. For example, the context of the data is analyzed, and inappropriate expressions are detected according to the context. By considering the context of the data, false detections are reduced and detection accuracy is improved. The detection criteria for inappropriate expressions are adjusted based on the context of the data. Thus, by considering the context of the data, the detection accuracy of inappropriate expressions can be improved. Some or all of the above-described processing in the detection unit may be performed using generative AI or without using generative AI. For example, the detection unit may input context data of the data into generative AI, and the generative AI improves the detection accuracy of inappropriate expressions. Specifically, the detection unit collects contextual information such as preceding and following text, conversation history, posting category, and related past posts, preprocesses them as token sequences, context embedding vectors, or time-series tensors, and integrates them as input tensors for generative AI. Examples of input include “A: This is a joke. B: People of XX are . . . ” or “Category: Satire, Posting history: Many jokes.” The generative AI uses a Transformer-based context understanding model and self-attention mechanism to map input data into a high-dimensional feature space and determines the presence or absence of inappropriate expressions at the token or sentence level depending on the context. The determination is output as binary labels (inappropriate/appropriate), multi-class classification (offensive, discriminatory, appropriate, etc.), or probability distributions (e.g., offensive 0.85, discriminatory 0.10, appropriate 0.05). Examples of output include “offensive: 0.92,” “discriminatory: 0.78.” The detection unit determines an expression as inappropriate if these output values exceed a predetermined threshold and passes the index and contextual information of the relevant portions to the correction unit. In subsequent processing, the detection results are linked to the correction unit or user interface, and context-dependent correction or display is performed. As a technical effect, the detection unit realizes significant improvement in detection accuracy and system reliability by context-dependent judgment in high-dimensional vector space by AI, which differs from conventional simple NG word replacement or human intuitive judgment, thereby fundamentally improving reduction of false detection and oversight. Application fields include monitoring of SNS posts, automatic FAQ generation, quality management of educational content, and customer support chatbots, contributing to improved user experience quality and operational efficiency.

The detection unit can detect inappropriate expressions by considering attribute information of the data poster at the time of detection. The detection unit uses generative AI to detect inappropriate expressions by considering attribute information of the data poster at the time of detection. The generative AI performs processing to consider attribute information of the data poster. For example, inappropriate expressions are detected by considering the age or gender of the data poster. The detection criteria are adjusted based on attribute information of the data poster. The optimal detection method is selected by analyzing attribute information of the data poster. Thus, by considering attribute information of the data poster, inappropriate expressions can be efficiently detected. Some or all of the above-described processing in the detection unit may be performed using generative AI or without using generative AI. For example, the detection unit may input attribute information data of the data poster into generative AI, and the generative AI detects inappropriate expressions. Specifically, the detection unit preprocesses attribute information such as age, gender, occupation, residential area, device used, and past posting trends of the poster as category embedding vectors or numerical vectors, integrates them with posting text or image data, and supplies them as input tensors for generative AI. Examples of input include “Age: 25, Gender: Male, Occupation: Student,” “Age: 60, Gender: Female, Occupation: Teacher.” The generative AI is equipped with a Transformer-based attribute information integration model and attribute-conditioned classification head, analyzes the correlation between poster attributes and posting content in high-dimensional feature space, and determines the presence or absence of inappropriate expressions with detection criteria optimized for each attribute. The determination is output as binary labels, multi-class classification, or probability distributions (e.g., offensive 0.80, discriminatory 0.15, appropriate 0.05). Examples of output include “offensive: 0.85,” “discriminatory: 0.10.” The detection unit determines an expression as inappropriate if these output values exceed a predetermined threshold and passes the index and attribute information of the relevant portions to the correction unit. In subsequent processing, the detection results are linked to the correction unit or user interface, and attribute-dependent correction or display is performed. As a technical effect, the detection unit realizes inappropriate expression detection optimized for diverse expressions and contexts for each attribute by dynamic criteria control based on attribute information integration analysis by AI, which differs from conventional uniform detection criteria or human intuitive judgment, thereby fundamentally improving reduction of false detection and oversight, detection accuracy, and system reliability. Application fields include monitoring of SNS posts, management of educational content, customer support, medical interview support, and user-adaptive interfaces, contributing to improved user experience quality and operational efficiency.

The detection unit can estimate a user's emotion and specifically adjust the display order of detection results based on the estimated user's emotion. The detection unit uses generative AI to estimate a user's emotion and specifically adjust the display order of detection results based on the estimated user's emotion. The generative AI performs processing to estimate the user's emotion. For example, if the user is feeling stressed, detection results with low importance are preferentially displayed. If the user is relaxed, detection results with high importance are preferentially displayed. If the user is in a hurry, detection results requiring rapid processing are preferentially displayed. Thus, by adjusting the display order of detection results according to the user's emotion, detection results can be efficiently displayed. Emotion estimation is realized using, for example, an emotion engine or generative AI with emotion estimation functions. The generative AI may be a text generative AI (e.g., LLM) or a multimodal generative AI, but is not limited to such examples. Some or all of the above-described processing in the detection unit may be performed using generative AI or without using generative AI. For example, the detection unit may input the user's emotion data into generative AI, and the generative AI adjusts the display order of detection results. Specifically, the detection unit collects multimodal emotion data such as user input text, audio data, facial images, and operation logs, applies preprocessing such as tokenization for text, spectrogram conversion for audio, facial feature extraction for images, and time-series vectorization for operation logs, and integrates them as input tensors for generative AI. Examples of input include text such as “I'm tired today,” “I'm calm,” images of expressionless or smiling faces, and operation patterns such as rapid tapping or long presses. The generative AI uses a Transformer-based multimodal emotion estimation model to integrate feature vectors of each modality and outputs emotion labels such as “stress,” “relaxation,” “impatience,” or probability distributions (e.g., stress 0.75, relaxation 0.18, impatience 0.07). Examples of output include “stress: 0.80,” “relaxation: 0.15.” The detection unit uses these emotion estimation results to automatically determine the display order of detection result lists (e.g., inappropriate expression detection results, warning lists) by combining importance scores or urgency scores with emotion labels. For example, if the stress value is high, detection results with low importance are displayed first; if the relaxation value is high, detection results with high importance are displayed first; if the impatience value is high, detection results with high urgency are displayed first. In subsequent processing, the display order results are reflected in the user interface or notification system, and the actual display order of detection results is controlled. As a technical effect, the detection unit realizes display of detection results optimized for the user's state by dynamic order control based on multi-dimensional feature analysis by AI, which differs from human subjective judgment or manual ordering, thereby fundamentally improving work efficiency, reducing user burden, and enhancing overall system responsiveness. Application fields include monitoring of SNS posts, educational dialogue systems, customer support, medical interview support, and user-adaptive interfaces, contributing to improved user experience quality and operational efficiency.

The detection unit can detect inappropriate expressions by considering the geographic distribution of the data at the time of detection. The detection unit uses generative AI to detect inappropriate expressions by considering the geographic distribution of the data at the time of detection. The generative AI performs processing to consider the geographic distribution of the data. For example, inappropriate expressions related to a specific region are preferentially detected. The detection criteria are adjusted based on the geographic distribution of the data. The optimal detection method is selected by analyzing the geographic distribution of the data. Thus, by considering the geographic distribution of the data, inappropriate expressions can be efficiently detected. Some or all of the above-described processing in the detection unit may be performed using generative AI or without using generative AI. For example, the detection unit may input geographic distribution data of the data into generative AI, and the generative AI detects inappropriate expressions. Specifically, the detection unit preprocesses geographic distribution data such as location information attached to posting data (e.g., latitude/longitude, region code, posting source IP address), regional distribution of posting counts, and regional topic trends as category embedding vectors or heatmap tensors, integrates them with posting text or image data, and supplies them as input tensors for generative AI. Examples of input include “latitude 35.6895, longitude 139.6917, posting count: Tokyo 100,” “region: Kansai, topic: festival.” The generative AI is equipped with a Transformer-based geographic information integration model and geographic distribution-conditioned classification head, analyzes the correlation between geographic features and posting content in high-dimensional feature space, and determines the presence or absence of inappropriate expressions with detection criteria optimized for each region. The determination is output as binary labels, multi-class classification, or probability distributions (e.g., offensive 0.80, discriminatory 0.15, appropriate 0.05). Examples of output include “offensive: 0.85,” “discriminatory: 0.10.” The detection unit determines an expression as inappropriate if these output values exceed a predetermined threshold and passes the index and geographic information of the relevant portions to the correction unit. In subsequent processing, the detection results are linked to the correction unit or user interface, and region-dependent correction or display is performed. As a technical effect, the detection unit realizes inappropriate expression detection optimized for diverse expressions and contexts for each region by dynamic criteria control based on geographic distribution integration analysis by AI, which differs from conventional uniform detection criteria or human intuitive judgment, thereby fundamentally improving reduction of false detection and oversight, detection accuracy, and system reliability. Application fields include monitoring of regional SNS posts, regional news distribution, tourist guide systems, disaster information monitoring, and regional community management, contributing to improved user experience quality and operational efficiency.

The detection unit can improve the detection accuracy of inappropriate expressions by referring to related literature at the time of detection. The detection unit uses generative AI to improve the detection accuracy of inappropriate expressions by referring to related literature at the time of detection. The generative AI performs processing to refer to related literature. For example, related literature is referred to, and inappropriate expressions are detected according to the context. By referring to related literature, false detections are reduced and detection accuracy is improved. The optimal detection method is selected by analyzing related literature. Thus, by referring to related literature, the detection accuracy of inappropriate expressions can be improved. Some or all of the above-described processing in the detection unit may be performed using generative AI or without using generative AI. For example, the detection unit may input related literature data of the data into generative AI, and the generative AI improves the detection accuracy of inappropriate expressions. Specifically, the detection unit preprocesses related literature data such as papers, articles, guidelines, FAQs, and past posts related to posting data as text embedding vectors, token sequences, or category vectors, integrates them with posting text or image data, and supplies them as input tensors for generative AI. Examples of input include “related paper: AI ethics guidelines,” “related FAQ: SNS posting regulations.” The generative AI is equipped with a Transformer-based literature reference model and context integration head, integratively analyzes posting content and related literature content in high-dimensional feature space, and determines the presence or absence of inappropriate expressions with optimal detection criteria based on literature. The determination is output as binary labels, multi-class classification, or probability distributions (e.g., offensive 0.80, discriminatory 0.15, appropriate 0.05). Examples of output include “offensive: 0.85,” “discriminatory: 0.10.” The detection unit determines an expression as inappropriate if these output values exceed a predetermined threshold and passes the index and literature information of the relevant portions to the correction unit. In subsequent processing, the detection results are linked to the correction unit or user interface, and literature-based correction or display is performed. As a technical effect, the detection unit realizes inappropriate expression detection tailored to context and norms by dynamic criteria control based on literature integration analysis by AI, which differs from conventional simple dictionary matching or human intuitive judgment, thereby fundamentally improving reduction of false detection and oversight, detection accuracy, and system reliability. Application fields include monitoring of academic paper submissions, monitoring of SNS posts, management of educational content, management of customer support FAQs, and compliance support, contributing to improved user experience quality and operational efficiency.

The correction unit can estimate a user's emotion and specifically adjust the manner of correction based on the estimated user's emotion. The correction unit uses generative AI to estimate a user's emotion and specifically adjust the manner of correction based on the estimated user's emotion. The generative AI performs processing to estimate the user's emotion. For example, if the user is feeling stressed, corrections are made using milder expressions. If the user is relaxed, corrections are made using detailed expressions. If the user is in a hurry, corrections are made using concise expressions. Thus, by adjusting the manner of correction according to the user's emotion, data can be efficiently corrected. Emotion estimation is realized using, for example, an emotion engine or generative AI with emotion estimation functions. The generative AI may be a text generative AI (e.g., LLM) or a multimodal generative AI, but is not limited to such examples. Some or all of the above-described processing in the correction unit may be performed using generative AI or without using generative AI. For example, the correction unit may input the user's emotion data into generative AI, and the generative AI adjusts the manner of correction. Specifically, the correction unit collects various multimodal data such as user input text (e.g., “I'm tired today,” “I'm in a hurry”), audio data (e.g., tone of voice, speaking speed), facial images (e.g., smiling, frowning), and operation logs (e.g., rapid tapping, long presses, input speed) to estimate the user's emotional state. The correction unit performs preprocessing such as tokenization for text, spectrogram conversion for audio, facial feature extraction for images, and time-series vectorization for operation logs, integrates all as input tensors (e.g., token ID sequence of maximum length 512, 128×128 facial feature vector, 24-dimensional operation time-series vector) for generative AI. Examples of input include text such as “I'm irritated today,” “I'm calm,” images of angry or smiling faces, and sudden operation patterns. The correction unit uses a Transformer-based multimodal emotion estimation model to integrate feature vectors of each modality via self-attention mechanisms and outputs multiple emotion labels such as “stress,” “relaxation,” “impatience,” or probability distributions (e.g., stress 0.82, relaxation 0.10, impatience 0.08). Examples of output include “stress: 0.85,” “relaxation: 0.12.” The correction unit uses these emotion estimation results in the correction expression control module to automatically select templates such as “mild expression” if the stress value is 0.7 or higher, “detailed expression” if the relaxation value is 0.5 or higher, or “concise expression” if the impatience value is high. Correction algorithms such as partial generation (infill) or full rewrite generation are used to automatically replace only the relevant part with expressions corresponding to the emotional state while maintaining context. For example, the offensive “You are useless” is converted to “You have different strengths” in a stress state, “I believe your opinion has diverse value” in a relaxed state, or “There are other perspectives” in a hurry. The generative AI uses a multi-layer neural network with Transformer architecture, extracts contextual information via self-attention mechanisms, generates multiple correction candidates, and automatically selects the one most suitable for the emotional state. Examples of output include “You have other qualities,” “People have strengths and weaknesses,” “There are diverse opinions.” In subsequent processing, the corrected data is passed to the addition unit and managed as paired data before and after correction. As a technical effect, the correction unit realizes correction expressions optimized for the user's state by dynamic expression control based on multi-dimensional feature analysis by AI, which differs from human subjective judgment or manual correction, thereby fundamentally improving work efficiency, reducing user burden, and enhancing overall system responsiveness. Furthermore, automatic optimization of correction expressions according to emotional state realizes computer-specific non-idiomatic processing methods in high-dimensional feature space, which differs from conventional uniform correction criteria or human intuitive judgment. Application fields include customer support, educational dialogue systems, medical interview support, monitoring of SNS posts, and user-adaptive interfaces, contributing to improved user experience quality and operational efficiency.

The correction unit can adjust the level of detail of correction based on the importance of the data at the time of correction. The correction unit uses a generative AI to adjust the level of detail of correction based on the importance of the data at the time of correction. The generative AI performs processing to evaluate the importance of the data. For example, for data with high importance, detailed correction is performed. For data with low importance, concise correction is performed. The level of detail of correction is adjusted based on the importance of the data. By adjusting the level of detail of correction based on the importance of the data, data can be efficiently corrected. Some or all of the above-described processing in the correction unit may be performed using generative AI, or may be performed without using generative AI. For example, the correction unit inputs data importance data to the generative AI, and the generative AI adjusts the level of detail of correction. Specifically, the correction unit collects metadata (e.g., usage frequency, number of references, user ratings, business priority, urgency, category, etc.) for each data in the dataset to assign an importance score, and preprocesses these as numerical vectors or category embedding vectors. Examples of input include “Number of references: 120, User rating: 4.8, Category: FAQ” and “Usage frequency: low, Urgency: high”. The correction unit uses a Transformer-based importance evaluation model or classification head to calculate importance scores (e.g., 0.95, 0.60, 0.20) from the input data, and automatically selects detailed correction (e.g., regeneration of the entire context or generation of multiple candidates) for high importance, and concise correction (e.g., partial replacement of only the relevant part) for low importance. Examples of output include “Importance: 0.92” and “Importance: 0.15”. Based on these importance scores, the correction algorithm control module dynamically adjusts detail parameters (e.g., number of correction tokens, regeneration range, presence/absence of explanation, etc.). For example, if the importance is 0.8 or higher, a “detailed correction with explanation” is applied, and if less than 0.5, a “concise correction” is applied. Correction algorithms may combine multiple methods such as partial generation (infill), full rewrite generation, and automatic addition of explanatory text. As a correction example, “This product is totally bad” is converted to “I felt this product did not meet my expectations. Details are ○○.” for high importance, and to “Did not meet expectations” for low importance. The generative AI extracts contextual information using a self-attention mechanism, generates multiple correction candidates, and automatically selects the one that best matches the importance. In subsequent processing, the corrected data is passed to the addition unit and managed as a pair of pre-and post-correction data. As a technical effect, the correction unit, unlike conventional uniform correction or human intuitive judgment, achieves optimal correction according to data importance through multidimensional feature analysis and dynamic detail control by AI, resulting in improved work efficiency, reduced erroneous corrections, enhanced system reliability, and essential improvements in computer technology. Application fields include automatic FAQ generation, customer support, educational content management, medical interview support, business task management, and contribute to operational efficiency and improved user experience quality.

The correction unit can apply different correction algorithms according to the category of the data at the time of correction. The correction unit uses a generative AI to apply different correction algorithms according to the category of the data at the time of correction. The generative AI performs processing to classify the category of the data. For example, for data related to a specific category, a dedicated correction algorithm is applied. The optimal correction algorithm is selected based on the category of the data. The correction algorithm is adjusted according to the category of the data. By applying the optimal correction algorithm according to the category of the data, data can be efficiently corrected. Some or all of the above-described processing in the correction unit may be performed using generative AI, or may be performed without using generative AI. For example, the correction unit inputs data category data to the generative AI, and the generative AI applies the correction algorithm. Specifically, the correction unit preprocesses category information assigned to each data in the dataset (e.g., question, answer, review, FAQ, medical, education, product description, etc.) as category embedding vectors or one-hot vectors, integrates them with post text or image data, and supplies them as input tensors to the generative AI. Examples of input include “Category: Review”, “Category: Medical”, “Category: FAQ”, etc. The correction unit uses a Transformer-based category classification model or conditional generation head to automatically select correction algorithms optimized for each category (e.g., rewrite for reviews, summary generation for FAQs, replacement of technical terms for medical data, etc.). Examples of output include “Review correction algorithm applied” and “FAQ correction algorithm applied”. Correction algorithms may combine multiple methods for each category, such as partial generation, full rewrite, technical term conversion, automatic addition of explanatory text, and summary generation. For example, in the review category, “This product is totally bad” is rewritten to “This product did not meet expectations”, and in the medical category, “○○ people are ~” is converted to “There are individual differences” as a professional and neutral expression. The generative AI integrally analyzes contextual and category information using a self-attention mechanism, and automatically generates and selects correction candidates that best match the category. In subsequent processing, the corrected data is passed to the addition unit and managed as a pair of pre-and post-correction data. As a technical effect, the correction unit, unlike conventional uniform correction or human intuitive judgment, achieves optimal correction for each category through AI-based category-conditioned generation and dynamic algorithm selection, resulting in improved work efficiency, reduced erroneous corrections, enhanced system reliability, and essential improvements in computer technology. Application fields include automatic FAQ generation, customer support, educational content management, medical interview support, product review management, and contribute to operational efficiency and improved user experience quality.

The correction unit can estimate a user's emotion and adjust the length of correction based on the estimated user's emotion. The correction unit uses a generative AI to estimate a user's emotion and adjust the length of correction based on the estimated user's emotion. The generative AI performs processing to estimate the user's emotion. For example, if the user is feeling stressed, a short correction is performed. If the user is relaxed, a long correction is performed. If the user is in a hurry, a rapid correction is performed. By adjusting the length of correction according to the user's emotion, data can be efficiently corrected. Emotion estimation is realized using an emotion engine or generative AI, for example, by employing an emotion estimation function. The generative AI may be a text generative AI (e.g., LLM) or a multimodal generative AI, but is not limited to such examples. Some or all of the above-described processing in the correction unit may be performed using generative AI, or may be performed without using generative AI. For example, the correction unit inputs user emotion data to the generative AI, and the generative AI adjusts the length of correction. Specifically, the correction unit collects multimodal data such as user input text, voice data, facial images, and operation logs to estimate the user's emotional state, preprocesses these (e.g., tokenization of text, spectrogram conversion of voice, facial feature extraction from images, time-series vectorization of operation logs), and integrates them as input tensors for the generative AI. Examples of input include text such as “I'm busy today” or “I'm calm”, low-tone voice waveforms, images of smiling or expressionless faces, and continuous operation patterns. The correction unit uses a Transformer-based multimodal emotion estimation model to integrate feature vectors of each modality, and outputs emotion labels such as “stress”, “relaxation”, “hurry” or probability distributions (e.g., stress 0.70, relaxation 0.20, hurry 0.10) via an emotion classification head. Examples of output include “Stress: 0.75” and “Relaxation: 0.18”. Based on these emotion estimation results, the correction length control module automatically adjusts the length parameter, such as shortening the number of correction tokens when the stress value is high, lengthening the number of correction tokens when the relaxation value is high, and selecting the shortest correction when the hurry value is high. Correction algorithms use partial generation or full rewrite generation to automatically replace only the relevant part with a length appropriate to the emotional state while maintaining context. As a correction example, “You're useless” is converted to “You have other strengths” in a stress state, “You have different strengths and can be active in various situations” in a relaxed state, and “The perspective is different” when in a hurry. The generative AI extracts contextual information using a self-attention mechanism, generates multiple correction candidates, and automatically selects the one with the most appropriate length for the emotional state. In subsequent processing, the corrected data is passed to the addition unit and managed as a pair of pre-and post-correction data. As a technical effect, the correction unit, unlike human subjective judgment or manual correction, achieves correction length optimized for the user's state through multidimensional feature analysis and dynamic length control by AI, resulting in improved work efficiency, reduced user burden, enhanced system responsiveness, and essential improvements in computer technology. Application fields include customer support, educational dialogue systems, medical interview support, SNS post monitoring, user-adaptive interfaces, and contribute to improved user experience quality and operational efficiency.

The correction unit can determine the priority of correction based on the posting time of the data at the time of correction. The correction unit uses a generative AI to determine the priority of correction based on the posting time of the data at the time of correction. The generative AI performs processing to evaluate the posting time of the data. For example, recently posted data is corrected preferentially. Older data is corrected later. The priority of correction is determined based on the posting time of the data. By determining the priority of correction based on the posting time of the data, data can be efficiently corrected. Some or all of the above-described processing in the correction unit may be performed using generative AI, or may be performed without using generative AI. For example, the correction unit inputs data posting time data to the generative AI, and the generative AI determines the priority of correction. Specifically, the correction unit preprocesses posting date and timestamp information (e.g., 2024 May 1 10:00, 2023 Dec. 31 23:59, etc.) assigned to each data in the dataset as numerical vectors or time-series tensors, integrates them with post text or image data, and supplies them as input tensors to the generative AI. Examples of input include “Posting date: 2024 May 1 10:00” and “Posting date: 2023 Dec. 31 23:59”. The correction unit uses a Transformer-based time-series analysis model or prioritization head to comprehensively analyze the recency, trend, and processing queue status in the system, and calculates correction priority scores (e.g., 0.95, 0.60, 0.20). Examples of output include “Priority: 0.92” and “Priority: 0.15”. Based on these priority scores, the correction queue control module executes correction processing in order from data with high priority, and postpones correction for data with low priority. Correction algorithms use partial generation or full rewrite generation to automatically replace only the relevant part while maintaining context. In subsequent processing, the corrected data is passed to the addition unit and managed as a pair of pre-and post-correction data. As a technical effect, the correction unit, unlike manual prioritization or human intuitive judgment, achieves optimal correction order according to posting time through time-series analysis and dynamic priority control by AI, resulting in improved work efficiency, reduced processing delay, enhanced system responsiveness, and essential improvements in computer technology. Application fields include SNS post monitoring, automatic FAQ generation, educational content management, customer support, business task management, and contribute to improved operational efficiency and user experience quality.

The correction unit can adjust the order of correction based on the relevance of the data at the time of correction. The correction unit uses a generative AI to adjust the order of correction based on the relevance of the data at the time of correction. The generative AI performs processing to evaluate the relevance of the data. For example, highly relevant data is corrected preferentially. Data with low relevance is corrected later. The order of correction is adjusted based on the relevance of the data. By adjusting the order of correction based on the relevance of the data, data can be efficiently corrected. Some or all of the above-described processing in the correction unit may be performed using generative AI, or may be performed without using generative AI. For example, the correction unit inputs data relevance data to the generative AI, and the generative AI adjusts the order of correction. Specifically, the correction unit preprocesses the relevance between each data in the dataset (e.g., same topic, same user, chronological continuity, reference relationships, similarity scores, etc.) as graph structures, similarity matrices, or category embedding vectors, integrates them with post text or image data, and supplies them as input tensors to the generative AI. Examples of input include “Topic: AI technology, Related data ID: 123, 124” and “User ID: A, Related posts: B, C”. The correction unit uses a Transformer-based relevance evaluation model or graph neural network to calculate relevance scores between data (e.g., 0.95, 0.60, 0.20), and executes correction processing in order from data with high relevance. Examples of output include “Relevance: 0.92” and “Relevance: 0.15”. Based on these relevance scores, the correction queue control module prioritizes correction for data with high relevance, and postpones correction for data with low relevance. Correction algorithms use partial generation or full rewrite generation to automatically replace only the relevant part while maintaining context. In subsequent processing, the corrected data is passed to the addition unit and managed as a pair of pre-and post-correction data. As a technical effect, the correction unit, unlike manual ordering or human intuitive judgment, achieves optimal correction order considering relationships between data through relevance analysis and dynamic order control by AI, resulting in improved work efficiency, ensured information consistency, enhanced system reliability, and essential improvements in computer technology. Application fields include automatic FAQ generation, customer support, educational content management, medical interview support, SNS post monitoring, and contribute to improved operational efficiency and user experience quality.

The addition unit can estimate a user's emotion and determine the priority of data to be added based on the estimated user's emotion. The addition unit uses a generative AI to estimate a user's emotion and determine the priority of data to be added based on the estimated user's emotion. The generative AI performs processing to estimate the user's emotion. For example, if the user is feeling stressed, data with low importance is preferentially added. If the user is relaxed, data with high importance is preferentially added. If the user is in a hurry, data requiring rapid processing is preferentially added. By determining the priority of data to be added according to the user's emotion, data can be efficiently added. Emotion estimation is realized using an emotion engine or generative AI, for example, by employing an emotion estimation function. The generative AI may be a text generative AI (e.g., LLM) or a multimodal generative AI, but is not limited to such examples. Some or all of the above-described processing in the addition unit may be performed using generative AI, or may be performed without using generative AI. For example, the addition unit inputs user emotion data to the generative AI, and the generative AI determines the priority of data to be added. Specifically, the addition unit collects multimodal data such as user input text (e.g., “I'm tired today”, “I'm in a hurry”), voice data (e.g., tone of voice, speaking speed), facial images (e.g., smile, frown), and operation logs (e.g., rapid tapping, long press, input speed) to estimate the user's emotional state. The addition unit preprocesses these data by tokenizing text, converting voice to spectrograms, extracting facial features from images, and vectorizing operation logs as time-series data, and integrates all as input tensors (e.g., ID sequence of up to 512 tokens, 128×128 facial feature vectors, 24-dimensional operation time-series vectors, etc.) for the generative AI. Examples of input include text such as “I'm irritated today”, “I'm calm”, images of angry or smiling faces, and rapid operation patterns. The generative AI uses a Transformer-based multimodal emotion estimation model to integrate feature vectors of each modality using a self-attention mechanism, and outputs multiple emotion labels such as “stress”, “relaxation”, “hurry” and probability distributions (e.g., stress 0.82, relaxation 0.10, hurry 0.08) via an emotion classification head. Examples of output include “Stress: 0.85” and “Relaxation: 0.12”. Based on these emotion estimation results, the addition unit automatically determines the priority of addition for candidate data (e.g., pre-and post-correction text pairs, records with metadata, etc.) by combining importance scores, urgency scores, and emotion labels. For example, when the stress value is high, data with low importance is added first; when the relaxation value is high, data with high importance is added first; and when the hurry value is high, data with high urgency is added first. In subsequent processing, the prioritization results are reflected in the database addition queue or storage management module, and the actual order of data addition is controlled. As a technical effect, the addition unit, unlike human subjective judgment or manual prioritization, achieves data addition optimized for the user's state through multidimensional feature analysis and dynamic priority control by AI, resulting in improved work efficiency, reduced user burden, enhanced system responsiveness, and essential improvements in computer technology. Furthermore, automatic optimization of addition priority according to emotional state realizes unconventional processing methods in the high-dimensional feature space unique to AI, unlike conventional uniform addition criteria or human intuitive judgment. Application fields include customer support, educational dialogue systems, medical interview support, SNS post monitoring, user-adaptive interfaces, and contribute to improved user experience quality and operational efficiency.

The addition unit can improve the accuracy of addition by considering the interrelationship of the data at the time of addition. The addition unit uses a generative AI to improve the accuracy of addition by considering the interrelationship of the data at the time of addition. The generative AI performs processing to evaluate the interrelationship of the data. For example, the interrelationship of the data is analyzed, and highly relevant data is preferentially added. The accuracy of addition is improved based on the interrelationship of the data. The optimal data is added by considering the interrelationship of the data. By considering the interrelationship of the data, the accuracy of addition can be improved. Some or all of the above-described processing in the addition unit may be performed using generative AI, or may be performed without using generative AI. For example, the addition unit inputs data interrelationship data to the generative AI, and the generative AI improves the accuracy of addition. Specifically, the addition unit preprocesses the relevance between each data in the dataset (e.g., same topic, same user, chronological continuity, reference relationships, similarity scores, etc.) as graph structures, similarity matrices, or category embedding vectors, integrates them with candidate data for addition, and supplies them as input tensors to the generative AI. Examples of input include “Topic: AI technology, Related data ID: 123, 124” and “User ID: A, Related posts: B, C”. The generative AI uses a Transformer-based relevance evaluation model or graph neural network to calculate relevance scores between data (e.g., 0.95, 0.60, 0.20), and executes addition processing in order from data with high relevance. Examples of output include “Relevance: 0.92” and “Relevance: 0.15”. Based on these relevance scores, the addition queue control module prioritizes addition for data with high relevance, and postpones addition for data with low relevance. In subsequent processing, the added data is recorded in the database or storage and managed together with relevance information. As a technical effect, the addition unit, unlike manual ordering or human intuitive judgment, achieves optimal addition order considering relationships between data through relevance analysis and dynamic order control by AI, resulting in improved work efficiency, ensured information consistency, enhanced system reliability, and essential improvements in computer technology. Application fields include automatic FAQ generation, customer support, educational content management, medical interview support, SNS post monitoring, and contribute to improved operational efficiency and user experience quality.

The addition unit can perform addition by considering attribute information of the data poster at the time of addition. The addition unit uses a generative AI to perform addition by considering attribute information of the data poster at the time of addition. The generative AI performs processing to evaluate attribute information of the data poster. For example, data with high relevance is added by considering the age and gender of the data poster. The optimal data is added based on attribute information of the data poster. Attribute information of the data poster is analyzed to improve the accuracy of addition. By considering attribute information of the data poster, highly relevant data can be added. Some or all of the above-described processing in the addition unit may be performed using generative AI, or may be performed without using generative AI. For example, the addition unit inputs attribute information data of the data poster to the generative AI, and the generative AI performs addition. Specifically, the addition unit preprocesses attribute information such as age, gender, occupation, residential area, device used, and past posting tendencies of the poster as category embedding vectors or numerical vectors, integrates them with candidate data for addition, and supplies them as input tensors to the generative AI. Examples of input include “Age: 25, Gender: Male, Occupation: Student” and “Age: 60, Gender: Female, Occupation: Teacher”. The generative AI is equipped with a Transformer-based attribute information integration model or attribute-conditioned classification head, analyzes the correlation between poster attributes and candidate data for addition in a high-dimensional feature space, and selects highly relevant data according to addition criteria optimized for each attribute. Examples of output include “Attribute suitability: 0.85” and “Attribute suitability: 0.10”. The addition unit executes addition processing when these output values exceed a predetermined threshold, and holds addition when below the threshold. In subsequent processing, the added data is recorded in the database or storage and managed together with attribute information. As a technical effect, the addition unit, unlike conventional uniform addition criteria or human intuitive judgment, achieves data addition optimized for diverse expressions and contexts for each attribute through attribute information integration analysis and dynamic criteria control by AI, resulting in reduced erroneous additions and omissions, greatly improved addition accuracy, enhanced system reliability, and essential improvements in computer technology. Application fields include SNS post monitoring, educational content management, customer support, medical interview support, user-adaptive interfaces, and contribute to improved user experience quality and operational efficiency.

The addition unit can adjust the display method of data to be added based on the estimated user's emotion. The addition unit uses a generative AI to estimate a user's emotion and adjust the display method of data to be added based on the estimated user's emotion. The generative AI performs processing to estimate the user's emotion. For example, if the user is feeling stressed, a simple display method is provided. If the user is relaxed, a detailed display method is provided. If the user is in a hurry, a method that enables rapid display is provided. By adjusting the display method of data to be added according to the user's emotion, data can be efficiently displayed. Emotion estimation is realized using an emotion engine or generative AI, for example, by employing an emotion estimation function. The generative AI may be a text generative AI (e.g., LLM) or a multimodal generative AI, but is not limited to such examples. Some or all of the above-described processing in the addition unit may be performed using generative AI, or may be performed without using generative AI. For example, the addition unit inputs user emotion data to the generative AI, and the generative AI adjusts the display method of data to be added. Specifically, the addition unit collects multimodal data such as user input text, voice data, facial images, and operation logs to estimate the user's emotional state, preprocesses these (e.g., tokenization of text, spectrogram conversion of voice, facial feature extraction from images, time-series vectorization of operation logs), and integrates them as input tensors for the generative AI. Examples of input include text such as “I'm tired today”, “I'm calm”, images of expressionless or smiling faces, and operation patterns such as rapid tapping or long press. The generative AI uses a Transformer-based multimodal emotion estimation model to integrate feature vectors of each modality, and outputs emotion labels such as “stress”, “relaxation”, “hurry” or probability distributions (e.g., stress 0.75, relaxation 0.18, hurry 0.07) via an emotion classification head. Examples of output include “Stress: 0.80” and “Relaxation: 0.15”. Based on these emotion estimation results, the display control module for added data automatically adjusts display parameters, such as simple display (e.g., summary only, icon display) when the stress value is high, detailed display (e.g., full text display, with explanation) when the relaxation value is high, and immediate display (e.g., popup, notification) when the hurry value is high. In subsequent processing, the display method is reflected in the user interface or notification system, and the actual data display is controlled. As a technical effect, the addition unit, unlike human subjective judgment or manual display switching, achieves data display optimized for the user's state through multidimensional feature analysis and dynamic display control by AI, resulting in improved work efficiency, reduced user burden, enhanced system responsiveness, and essential improvements in computer technology. Application fields include customer support, educational dialogue systems, medical interview support, SNS post monitoring, user-adaptive interfaces, and contribute to improved user experience quality and operational efficiency.

The addition unit can perform addition by considering the geographic distribution of the data at the time of addition. The addition unit uses a generative AI to perform addition by considering the geographic distribution of the data at the time of addition. The generative AI performs processing to evaluate the geographic distribution of the data. For example, data related to a specific region is preferentially added. The optimal data is added based on the geographic distribution of the data. The geographic distribution of the data is analyzed to improve the accuracy of addition. By considering the geographic distribution of the data, highly relevant data can be added. Some or all of the above-described processing in the addition unit may be performed using generative AI, or may be performed without using generative AI. For example, the addition unit inputs geographic distribution data of the data to the generative AI, and the generative AI performs addition. Specifically, the addition unit preprocesses geographic distribution data such as location information (e.g., latitude/longitude, region code, posting source IP address), regional distribution of post counts, and regional topic trends associated with candidate data for addition as category embedding vectors or heatmap tensors, integrates them with candidate data for addition, and supplies them as input tensors to the generative AI. Examples of input include “Latitude 35.6895, Longitude 139.6917, Number of posts: Tokyo 100”, “Region: Kansai, Topic: Festival”. The generative AI is equipped with a Transformer-based geographic information integration model or geographic distribution-conditioned classification head, analyzes the correlation between geographic features and candidate data for addition in a high-dimensional feature space, and selects highly relevant data according to addition criteria optimized for each region. Examples of output include “Region suitability: 0.85” and “Region suitability: 0.10”. The addition unit executes addition processing when these output values exceed a predetermined threshold, and holds addition when below the threshold. In subsequent processing, the added data is recorded in the database or storage and managed together with geographic information. As a technical effect, the addition unit, unlike conventional uniform addition criteria or human intuitive judgment, achieves data addition optimized for diverse expressions and contexts for each region through geographic distribution integration analysis and dynamic criteria control by AI, resulting in reduced erroneous additions and omissions, greatly improved addition accuracy, enhanced system reliability, and essential improvements in computer technology. Application fields include regional SNS post monitoring, regional news distribution, tourism guidance systems, disaster information monitoring, regional community management, and contribute to improved user experience quality and operational efficiency.

The addition unit can improve the accuracy of addition by referring to related literature at the time of addition. The addition unit uses a generative AI to improve the accuracy of addition by referring to related literature at the time of addition. The generative AI performs processing to refer to related literature of the data. For example, related literature is referred to, and highly relevant data is added. The accuracy of addition is improved based on related literature. Related literature is analyzed to add optimal data. By referring to related literature, the accuracy of addition can be improved. Some or all of the above-described processing in the addition unit may be performed using generative AI, or may be performed without using generative AI. For example, the addition unit inputs related literature data of the data to the generative AI, and the generative AI improves the accuracy of addition. Specifically, the addition unit preprocesses related literature data such as papers, articles, guidelines, FAQs, and past posts related to candidate data for addition as text embedding vectors, token sequences, or category vectors, integrates them with candidate data for addition, and supplies them as input tensors to the generative AI. Examples of input include “Related paper: AI Ethics Guidelines” and “Related FAQ: SNS Posting Rules”. The generative AI is equipped with a Transformer-based literature reference model or context integration head, integrally analyzes the content of candidate data for addition and related literature in a high-dimensional feature space, and selects highly relevant data according to addition criteria based on literature. Examples of output include “Literature suitability: 0.85” and “Literature suitability: 0.10”. The addition unit executes addition processing when these output values exceed a predetermined threshold, and holds addition when below the threshold. In subsequent processing, the added data is recorded in the database or storage and managed together with literature information. As a technical effect, the addition unit, unlike simple dictionary matching or human intuitive judgment, achieves data addition in accordance with context and norms through related literature integration analysis and dynamic criteria control by AI, resulting in reduced erroneous additions and omissions, greatly improved addition accuracy, enhanced system reliability, and essential improvements in computer technology. Application fields include academic paper submission monitoring, SNS post monitoring, educational content management, customer support FAQ management, compliance support, and contribute to improved user experience quality and operational efficiency.

The system according to the embodiment is not limited to the above-described examples, and various modifications are possible, for example, as follows. Specifically, the system has a structure that allows flexible changes to the combination and processing flow of each component such as the input unit, detection unit, correction unit, addition unit, and feedback collection unit. The system can use a combination of multiple AI modules as the architecture for AI models, such as Transformer-based large language models, multimodal neural networks, graph neural networks, and time-series analysis models. For example, in the input unit, a multimodal model specialized for user emotion estimation and a time-series model for posting history analysis can operate in parallel, and in the detection unit, a context understanding model and an attribute information integration model can be linked hierarchically. Furthermore, in the correction unit, a category-conditioned generation model and an importance control generation model can be switched dynamically, and in the addition unit, a relevance evaluation model and a geographic information integration model can be combined to optimize candidate data for addition. Input data to AI can be various data types such as text, voice, image, operation log, location information, attribute information, and related literature data, tensorized and supplied as input tensors to each AI module. For example, user input text (maximum length 512 tokens), voice spectrogram (128×128 array), facial feature vector (128 dimensions), operation log time-series vector (24 dimensions), latitude/longitude array (float32 type), category embedding vector (16 dimensions), etc. are specific examples. AI outputs include emotion label probability distributions (e.g., stress 0.82, relaxation 0.10), recommended input method scores (e.g., voice 0.75, text 0.20), relevance scores (e.g., 0.92, 0.60, 0.20), correction candidate text, priority scores, display control parameters, etc., and these output values are linked to subsequent control modules, user interfaces, and database management systems. In subsequent processing, input timing control, data filtering, prioritization, correction algorithm selection, addition order control, display method adjustment, etc. are automatically executed based on AI output. As a technical effect, the system, unlike conventional static rule-based processing or human intuitive judgment, achieves high-dimensional feature analysis and dynamic control through cooperation of multiple AI modules, resulting in improved processing accuracy, reduced erroneous detection and correction, enhanced system responsiveness, ensured information consistency, improved user experience quality, and essential improvements in computer technology. Application fields include SNS post monitoring, educational content management, customer support, medical interview support, automatic FAQ generation, personalized recommendation, regional information distribution, compliance support, and contribute to operational efficiency and optimization of information distribution in various fields. Furthermore, it directly leads to improvements in computer technology itself, such as improved learning efficiency and accuracy of AI models, reduced bias, and increased flexibility in data management.

The dataset correction system may further include a feedback collection unit configured to collect user feedback. The feedback collection unit collects user evaluations and opinions regarding the corrected data and feeds them back to the generative AI. For example, a questionnaire is provided to evaluate whether the user is satisfied with the corrected data. A function is provided for the user to propose specific improvements to the correction. Based on user feedback, the correction algorithm of the generative AI is improved. By utilizing user feedback, the accuracy and user satisfaction of the dataset correction system can be improved. Specifically, the dataset correction system collects various feedback data from users (e.g., 5-point rating scores, free-text comments, selection of correction candidates, improvement request tags, etc.) through the feedback collection unit, and preprocesses these as structured data (e.g., numerical vectors, category embeddings, text token sequences). Examples of input include “Rating score: 4, Comment: The expression became softer and is good”, “Rating score: 2, Comment: I want it to be more specific”, “Improvement tag: Request for more detail”, etc. The system uses these feedback data as additional training data for the generative AI or as reward signals for reinforcement learning, and automatically optimizes correction algorithm parameters and updates generation templates. As AI models, reward models and supervised additional training modules that take feedback data as input are combined, and weights are dynamically adjusted so that expressions with high user ratings are preferentially output when generating correction candidates. AI outputs include rankings of correction candidate texts, user satisfaction prediction scores, improvement point extraction results, etc., and these are reflected in the algorithm control of the correction unit and the management of correction history in the database. In subsequent processing, the correction results after feedback reflection are presented to the user again, and a continuous feedback loop is formed, so that the accuracy and user satisfaction of the entire system are gradually improved. As a technical effect, the system, unlike conventional one-way correction processing or manual human evaluation, achieves dynamic algorithm optimization driven by AI feedback, resulting in continuous improvement of correction accuracy, rapid adaptation to user needs, enhanced self-evolution capability of the system, and essential improvements in computer technology. Application fields include automatic FAQ generation, educational content management, customer support, SNS post monitoring, medical interview support, and contribute greatly to improved user experience quality and operational efficiency.

The detection unit can detect inappropriate expressions by considering the context of the data. For example, expressions that are acceptable in a specific context may be considered inappropriate in another context. The detection unit analyzes the context of the data using a context analysis algorithm and applies appropriate detection criteria. This enables flexible detection according to context and reduces false detections. For example, in contexts containing jokes or satirical expressions, expressions that would normally be considered inappropriate may be acceptable. The detection unit accurately analyzes these contexts and applies appropriate criteria to improve detection accuracy. Specifically, the detection unit collects contextual information such as preceding and following text, conversation history, posting category, and related past posts, preprocesses these as token sequences, context embedding vectors, or time-series tensors, and integrates them as input tensors for the generative AI. Examples of input include “A: This is a joke B: ○○ people are ~” and “Category: Satire, Posting history: Many jokes”. The detection unit uses a Transformer-based context understanding model or self-attention mechanism to map input data into a high-dimensional feature space and determines the presence or absence of inappropriate expressions for each token or sentence in a context-dependent manner. Determination is output as binary labels (inappropriate/appropriate), multi-class classification (offensive, discriminatory, appropriate, etc.), or probability distributions (e.g., offensive 0.85, discriminatory 0.10, appropriate 0.05). Examples of output include “Offensive: 0.92” and “Discriminatory: 0.78”. The detection unit determines an expression to be inappropriate if these output values exceed a predetermined threshold, and passes the index and context information of the relevant part to the correction unit. In subsequent processing, detection results are linked to the correction unit and user interface, and context-dependent correction and display are performed. As a technical effect, the detection unit, unlike simple NG word replacement or human intuitive judgment, achieves context-dependent judgment in a high-dimensional vector space by AI, resulting in reduced false detections and omissions, greatly improved detection accuracy, enhanced system reliability, and essential improvements in computer technology. Application fields include SNS post monitoring, automatic FAQ generation, quality control of educational content, customer support chatbots, and contribute to improved user experience quality and operational efficiency.

The correction unit can estimate a user's emotion and adjust the expression method of correction based on the estimated user's emotion. For example, if the user is feeling stressed, the correction is made using a gentle expression method. If the user is relaxed, the correction is made using a detailed expression method. If the user is in a hurry, the correction is made using a concise expression method. By adjusting the expression method of correction according to the user's emotion, data can be efficiently corrected. Emotion estimation is realized using an emotion engine or generative AI, for example, by employing an emotion estimation function. The generative AI may be a text generative AI (e.g., LLM) or a multimodal generative AI, but is not limited to such examples. Specifically, the correction unit collects multimodal data such as user input text (e.g., “I'm tired today”, “I'm in a hurry”), voice data (e.g., tone of voice, speaking speed), facial images (e.g., smile, frown), and operation logs (e.g., rapid tapping, long press, input speed) to estimate the user's emotional state. The correction unit preprocesses these data by tokenizing text, converting voice to spectrograms, extracting facial features from images, and vectorizing operation logs as time-series data, and integrates all as input tensors (e.g., ID sequence of up to 512 tokens, 128×128 facial feature vectors, 24-dimensional operation time-series vectors, etc.) for the generative AI. Examples of input include text such as “I'm irritated today”, “I'm calm”, images of angry or smiling faces, and rapid operation patterns. The correction unit uses a Transformer-based multimodal emotion estimation model to integrate feature vectors of each modality using a self-attention mechanism, and outputs multiple emotion labels such as “stress”, “relaxation”, “hurry” and probability distributions (e.g., stress 0.82, relaxation 0.10, hurry 0.08) via an emotion classification head. Examples of output include “Stress: 0.85” and “Relaxation: 0.12”. Based on these emotion estimation results, the correction expression control module selects, for example, a “gentle expression” template when the stress value is 0.7 or higher, a “detailed expression” template when the relaxation value is 0.5 or higher, and a “concise expression” template when the hurry value is high. Correction algorithms use partial generation (infill) or full rewrite generation to automatically replace only the relevant part with an expression appropriate to the emotional state while maintaining context. For example, the offensive “You're useless” is converted to “You have different strengths” in a stress state, “I believe your opinion has diverse value” in a relaxed state, and “There is another perspective” when in a hurry. The generative AI uses a multi-layer neural network with a Transformer architecture, extracts contextual information using a self-attention mechanism, generates multiple correction candidates, and automatically selects the one that best matches the emotional state. Examples of output include “You have other strengths”, “People have strengths and weaknesses”, “There are diverse opinions”. In subsequent processing, the corrected data is passed to the addition unit and managed as a pair of pre-and post-correction data. As a technical effect, the correction unit, unlike human subjective judgment or manual correction, achieves correction expressions optimized for the user's state through multidimensional feature analysis and dynamic expression control by AI, resulting in improved work efficiency, reduced user burden, enhanced system responsiveness, and essential improvements in computer technology. Furthermore, automatic optimization of correction expressions according to emotional state realizes unconventional processing methods in the high-dimensional feature space unique to AI, unlike conventional uniform correction criteria or human intuitive judgment. Application fields include customer support, educational dialogue systems, medical interview support, SNS post monitoring, user-adaptive interfaces, and contribute to improved user experience quality and operational efficiency.

The correction unit can adjust the level of detail of correction based on the importance of the data at the time of correction. For example, for data with high importance, detailed correction is performed. For data with low importance, concise correction is performed. The level of detail of correction is adjusted based on the importance of the data. By adjusting the level of detail of correction based on the importance of the data, data can be efficiently corrected. Some or all of the above-described processing in the correction unit may be performed using generative AI, or may be performed without using generative AI. For example, the correction unit inputs data importance data to the generative AI, and the generative AI adjusts the level of detail of correction. Specifically, the correction unit collects metadata (e.g., usage frequency, number of references, user ratings, business priority, urgency, category, etc.) for each data in the dataset to assign an importance score, and preprocesses these as numerical vectors or category embedding vectors. Examples of input include “Number of references: 120, User rating: 4.8, Category: FAQ” and “Usage frequency: low, Urgency: high”. The correction unit uses a Transformer-based importance evaluation model or classification head to calculate importance scores (e.g., 0.95, 0.60, 0.20) from the input data, and automatically selects detailed correction (e.g., regeneration of the entire context or generation of multiple candidates) for high importance, and concise correction (e.g., partial replacement of only the relevant part) for low importance. Examples of output include “Importance: 0.92” and “Importance: 0.15”. Based on these importance scores, the correction algorithm control module dynamically adjusts detail parameters (e.g., number of correction tokens, regeneration range, presence/absence of explanation, etc.). For example, if the importance is 0.8 or higher, a “detailed correction with explanation” is applied, and if less than 0.5, a “concise correction” is applied. Correction algorithms may combine multiple methods such as partial generation (infill), full rewrite generation, and automatic addition of explanatory text. As a correction example, “This product is totally bad” is converted to “I felt this product did not meet my expectations. Details are ○○.” for high importance, and to “Did not meet expectations” for low importance. The generative AI extracts contextual information using a self-attention mechanism, generates multiple correction candidates, and automatically selects the one that best matches the importance. In subsequent processing, the corrected data is passed to the addition unit and managed as a pair of pre-and post-correction data. As a technical effect, the correction unit, unlike conventional uniform correction or human intuitive judgment, achieves optimal correction according to data importance through multidimensional feature analysis and dynamic detail control by AI, resulting in improved work efficiency, reduced erroneous corrections, enhanced system reliability, and essential improvements in computer technology. Application fields include automatic FAQ generation, customer support, educational content management, medical interview support, business task management, and contribute to operational efficiency and improved user experience quality.

The addition unit can retain both the data before correction and the data after correction. For example, the original text data is retained as data before correction, and the corrected text data is retained as data after correction. This enables the construction of a high-quality dataset without reducing the number of data. Some or all of the above-described processing in the addition unit may be performed using generative AI, or may be performed without using generative AI. For example, the addition unit inputs both the data before correction and the data after correction to the generative AI, and the generative AI retains both data. Specifically, the addition unit records pairs of pre- and post-correction text data, related metadata (e.g., reason for correction, correction date and time, correction AI model ID, etc.), emotion estimation values before and after correction, importance scores, etc. together in the database. Examples of input include “Before correction: This product is totally bad, After correction: I felt this product did not meet my expectations”, “Before correction: ○○ people are ~, After correction: There are individual differences”, etc. The addition unit manages these data as structured records (e.g., JSON format, RDB tables, NoSQL documents, etc.), realizing traceability and version management of correction history. The AI model can reuse pairs of pre-and post-correction data as supervised learning data to continuously improve the accuracy of correction algorithms and reduce bias. AI outputs include similarity scores between pre-and post-correction data, correction content classification labels, unique IDs for history management, etc., and these are reflected in database indexes and search functions. In subsequent processing, pre-and post-correction data are linked to the quality management unit and feedback collection unit, and used as triggers for user evaluation and re-correction requests. As a technical effect, the addition unit, unlike conventional overwriting or simple history management, achieves dynamic management and utilization of pre-and post-correction pair data by AI, greatly improving the diversity, quality, and reusability of the dataset, and bringing essential improvements in computer technology such as improved learning efficiency and system reliability. Application fields include automatic FAQ generation, educational content management, customer support, SNS post monitoring, medical interview support, and contribute to data quality assurance and the construction of continuous improvement cycles.

The input unit can estimate a user's emotion and adjust the timing of data input based on the estimated user's emotion. For example, if the user is feeling stressed, the timing of data input is delayed until the user relaxes. If the user is relaxed, the timing of data input is accelerated to input data efficiently. If the user is in a hurry, the timing of data input is optimized to input data quickly. By adjusting the timing of data input according to the user's emotion, data can be efficiently input. Emotion estimation is realized using an emotion engine or generative AI, for example, by employing an emotion estimation function. The generative AI may be a text generative AI (e.g., LLM) or a multimodal generative AI, but is not limited to such examples. Specifically, the input unit collects multimodal data such as user input text, voice data, facial images, and operation logs to estimate the user's emotional state, preprocesses these (e.g., tokenization of text, spectrogram conversion of voice, facial feature extraction from images, time-series vectorization of operation logs), and integrates them as input tensors for the generative AI. Examples of input include text such as “I'm tired today”, “I'm in a hurry”, high-tone voice waveforms, images of smiling or frowning faces, and operation patterns such as rapid tapping or long press. The generative AI uses a Transformer-based multimodal neural network to integrate feature vectors of each modality using a self-attention mechanism, and outputs multiple emotion labels such as “stress”, “relaxation”, “tension”, “hurry” and probability distributions for each emotion (e.g., stress 0.82, relaxation 0.10, hurry 0.08) via an emotion classification head. Examples of output include “Stress: 0.85” and “Relaxation: 0.12”. Based on these emotion estimation results, the data input timing control module automatically adjusts timing by threshold judgment and branching logic, such as waiting for input when the stress value is 0.7 or higher, immediate input when the relaxation value is 0.5 or higher, and shortening the input interval when the hurry value is high. In subsequent processing, the input timing control result is transmitted to the user interface or batch processing scheduler, and the actual timing of data input is controlled. As a technical effect, the input unit, unlike human subjective judgment or manual timing adjustment, achieves input timing control optimized for the user's state through AI inference integrating high-dimensional features of multiple modalities, resulting in improved processing efficiency, reduced user stress, enhanced system responsiveness, and essential improvements in computer technology. Application fields include customer support chatbots, educational dialogue systems, medical interview support, stress management applications, user-adaptive interfaces, and contribute to improved user experience quality and operational efficiency in these fields.

The input unit can analyze a user's past posting history at the time of data input and select the optimal input method. For example, the input method (voice, text, etc.) frequently used by the user in the past is preferentially suggested. The input method related to a specific category is suggested based on the user's past posting history. The most efficient input method is selected by analyzing the user's past posting history. By analyzing the user's past posting history, the optimal input method can be selected. Some or all of the above-described processing in the input unit may be performed using generative AI, or may be performed without using generative AI. For example, the input unit inputs the user's past posting history data to the generative AI, and the generative AI selects the optimal input method. Specifically, the input unit extracts multidimensional structured data such as posting date and time, posting content, input method used (e.g., voice input, text input, handwriting input, image upload, etc.), posting category (e.g., question, answer, review, etc.), and device information at the time of posting (e.g., smartphone, PC, tablet) from the user's past posting history database, and formats these as time-series vectors or category embedding vectors for the generative AI's input tensor. Examples of input include history data such as “2024 May 1 10:00 Text Question”, “2024 May 2 12:30 Voice Answer”, “2024 May 3 09:15 Image Review”. The generative AI is equipped with a Transformer-based time-series analysis model or category classification head, extracts frequency distributions of past input methods and usage trends by category using a self-attention mechanism, and outputs scores for each user such as “Voice input recommendation score 0.75”, “Text input recommendation score 0.20”, “Image input recommendation score 0.05”. Examples of output include “Voice input: 0.82” and “Text input: 0.15”. Based on these recommendation scores, the input unit automatically selects and suggests the optimal input method on the user interface, and when the user selects it, the selection history is fed back as learning data. In subsequent processing, the recommended input method is reflected in dialog boxes, button placement, activation of voice recognition modules, etc. As a technical effect, the input unit, unlike conventional static input method selection or manual switching by the user, greatly improves input efficiency and user satisfaction through AI-based history analysis and dynamic recommendation, and enhances system adaptability and flexibility. Application fields include automatic FAQ response systems, customer support, educational platforms, medical interview systems, assistive interfaces for people with disabilities, and can provide optimal input experiences tailored to user characteristics.

The input unit can perform filtering based on the user's current field of interest at the time of data input. For example, data related to topics the user is currently interested in is preferentially input. Data with high relevance is filtered based on the user's current field of interest. The optimal data is selected by considering the user's current field of interest. By filtering data based on the user's current field of interest, highly relevant data can be input. Some or all of the above-described processing in the input unit may be performed using generative AI, or may be performed without using generative AI. For example, the input unit inputs the user's current field of interest data to the generative AI, and the generative AI performs filtering of the data. Specifically, the input unit collects various behavioral data such as the user's recent browsing history, search queries, click logs, “likes” and comment history on SNS, and survey responses, preprocesses these as token sequences, category embedding vectors, or time-series tensors, and formats them as input tensors for the generative AI. Examples of input include topic labels such as “AI technology”, “health management”, “travel”, and history data such as “2024 May 1 Search: Natural Language Processing”, “2024 May 2 Browsing: Medical AI”. The generative AI uses a Transformer-based topic classification model or attention mechanism to output multi-class classification (e.g., AI 0.65, health 0.20, travel 0.15) or topic ranking from user behavioral data. Examples of output include “AI: 0.72”, “Health: 0.18”, “Travel: 0.10”. Based on these field of interest scores, the input unit calculates relevance scores for candidate data obtained from databases or external APIs, and filters only data with a predetermined threshold (e.g., 0.5) or higher as input candidates. In subsequent processing, the filtering results are passed to the user interface or automatic input module, and the optimal data is presented and input to the user. As a technical effect, the input unit, unlike conventional static category selection or simple keyword matching, achieves data input tailored to the user's current interests through dynamic estimation of fields of interest and relevance calculation in a high-dimensional feature space by AI, greatly reducing information excess and noise. Application fields include recommendation systems, personalized learning support, news distribution, e-commerce product suggestions, medical information provision, and contribute to improved user experience quality and operational efficiency.

The input unit is capable of estimating a user's emotion and determining the priority of data to be input based on the estimated user's emotion. For example, when the user is feeling stressed, data with lower importance is preferentially input. When the user is relaxed, data with higher importance is preferentially input. When the user is in a hurry, data requiring prompt processing is preferentially input. By determining the priority of data to be input according to the user's emotion, data can be input efficiently. Emotion estimation is realized, for example, by using an emotion estimation function implemented with an emotion engine or generative AI. The generative AI may be a text generation AI (e.g., LLM) or a multimodal generative AI, but is not limited to such examples. Specifically, the input unit collects multimodal data such as user input text, voice data, facial images, and operation logs to estimate the user's emotional state, performs preprocessing (e.g., tokenization of text, spectrogram conversion of voice, facial feature extraction from images, time-series vectorization of operation logs), and integrates these as input tensors for the generative AI. Examples of input include text such as “I am busy today” or “I am calm,” low-tone voice waveforms, images of smiling or expressionless faces, and continuous operation patterns. The generative AI uses a Transformer-based multimodal neural network to integrate feature vectors of each modality and, via an emotion classification head, outputs emotion labels such as “stress,” “relaxation,” “impatience,” and probability distributions (e.g., stress 0.70, relaxation 0.20, impatience 0.10). Example outputs include “stress: 0.75” and “relaxation: 0.18.” Based on these emotion estimation results, the input unit automatically determines the priority of candidate data to be input (e.g., unanswered questions, notifications, tasks) by combining importance scores or urgency scores with emotion labels. For example, when the stress value is high, data with lower importance is input in order; when the relaxation value is high, data with higher importance is input in order; when the impatience value is high, data with higher urgency is preferentially input. As a subsequent process, the prioritization results are reflected in the input queue or user interface, and the actual data input order is controlled. As a technical effect, the input unit, unlike human subjective judgment or manual prioritization, achieves data input optimized for the user's state through multidimensional feature analysis and dynamic priority control by AI, thereby improving work efficiency, reducing user burden, and fundamentally enhancing the responsiveness of the entire system as a computer technology. Application fields include customer support, educational dialogue systems, medical interview support, business task management, and user-adaptive interfaces, contributing to improved user experience quality and operational efficiency.

The input unit is capable of preferentially inputting highly relevant data by considering the user's geographic location information at the time of data input. The input unit uses generative AI to preferentially input highly relevant data by considering the user's geographic location information at the time of data input. The generative AI performs processing to consider the user's geographic location information. For example, when the user is in a specific region, data related to that region is preferentially input. Highly relevant data is filtered based on the user's geographic location information. The optimal data is selected based on the user's current location. Thus, by considering the user's geographic location information, highly relevant data can be preferentially input. Some or all of the above-described processing in the input unit may be performed using generative AI, or may be performed without using generative AI. For example, the input unit inputs the user's geographic location information data to the generative AI, and the generative AI preferentially inputs highly relevant data. Specifically, the input unit collects geographic location information such as GPS coordinates of the user terminal, region estimation from IP address, Wi-Fi access point information, and location history, and formats these as latitude-longitude vectors or category labels (e.g., city name, prefecture, country name) for the input tensor of the generative AI. Examples of input include “latitude 35.6895 longitude 139.6917 (Tokyo)”, “IP address: 203.0.113.1 (Osaka)” and so on. The generative AI uses a Transformer-based geographic information embedding model and a relevance calculation head for location information and data attributes to output relevance scores between the user's current location and the regional attributes of each data in the database (e.g., event location, store location, region-specific news, etc.) (e.g., 0.85, 0.60, 0.10). Example outputs include “Tokyo-related data: 0.92” and “Osaka-related data: 0.15.” Based on these relevance scores, the input unit preferentially selects data with a predetermined threshold (e.g., 0.7) or higher as input candidates and reflects them in the user interface or automatic input module. As a subsequent process, prioritized input data is used for map-linked UIs or region-specific notifications. As a technical effect, the input unit, unlike conventional static region filters or manual selection, achieves optimal data input tailored to the user's current location through dynamic geographic information analysis and relevance calculation in a high-dimensional feature space by AI, greatly reducing information excess, deficiency, and noise. Application fields include regional information distribution, tourist guidance, disaster information notification, local event recommendation, and region-specific service provision, contributing to improved user experience quality and operational efficiency.

Below, the processing flow of Example of the Embodiment is briefly described. Specifically, the dataset correction system is composed of multiple modules such as an input unit, a detection unit, a correction unit, and an addition unit, and each module cooperates to automate the detection, correction, and management of inappropriate expressions in the dataset. First, the input unit sequentially or in batch receives various data such as user-posted questions and answers, review comments, images, and audio, performs preprocessing for natural language processing and image/audio processing (e.g., tokenization, normalization, removal of unnecessary words, spectrogram conversion, image feature extraction), and formats them as input tensors for the generative AI (e.g., token ID sequences, pixel value arrays, audio spectrogram arrays). Next, the detection unit uses a pre-trained large language model or multimodal model (e.g., Transformer-based autoregressive model, encoder-decoder model) to convert the input data into high-dimensional feature vectors through multi-layer self-attention mechanisms, and determines the presence or absence of inappropriate expressions for each token or sentence. The determination is output as binary labels (inappropriate/appropriate), multi-class classification (offensive, discriminatory, appropriate, etc.), or probability distributions (e.g., offensive 0.85, discriminatory 0.10, appropriate 0.05), and when a predetermined threshold is exceeded, the expression is judged as inappropriate, and the index and context information of the relevant part are passed to the correction unit. The correction unit uses algorithms such as partial generation (infill) or overall rewrite generation to automatically replace only the relevant part with neutral or gentle expressions while maintaining context. For example, “Your opinion is completely useless” is converted to “There are different perspectives on your opinion.” The corrected data is added to the original dataset as a new record by the addition unit and managed as paired data before and after correction. The addition unit attaches correction history and metadata (correction date, correction reason, detection score, etc.) in the database and utilizes them for subsequent selection of training data and quality management. As a technical effect, the system achieves significant improvement in processing speed and accuracy with consistent judgment criteria compared to manual visual checks and manual corrections, enabling large-scale data expansion and cleansing while maintaining dataset quality. Furthermore, the detection and correction algorithms realize context-dependent judgments that are difficult with rule-based methods by extracting features in high-dimensional vector spaces, and adopt computer-specific unconventional processing methods that differ from conventional simple NG word replacement or human intuitive judgment. Application fields include construction of training datasets for natural language processing, monitoring of SNS posts, automatic generation of FAQs, preparation of training data for customer support chatbots, and quality management of educational content. In these fields, the present invention exhibits remarkable technical effects such as homogenization and improvement of data quality, reduction of AI model bias, suppression of false detection and false correction, and reduction of operational costs.

Step 1: The input unit inputs each data in the dataset. The dataset may include, for example, questions and answers posted by users, but is not limited thereto. The input unit, for example, inputs each data in the dataset to the generative AI. The generative AI is prepared to analyze the data. Step 2: The detection unit analyzes the data input by the input unit using the generative AI and detects inappropriate expressions. The generative AI uses a pre-trained model to identify inappropriate expressions in the data. For example, discriminatory expressions and offensive words are detected as inappropriate expressions. The generative AI is required to detect inappropriate expressions with high accuracy. Step 3: The correction unit corrects the inappropriate expressions detected by the detection unit to appropriate expressions using the generative AI. The generative AI performs corrections to replace the detected inappropriate expressions with appropriate expressions. For example, discriminatory expressions are corrected to neutral expressions, and offensive words are replaced with gentle words. This improves the quality of the data. Step 4: The addition unit adds the data corrected by the correction unit to the original dataset. Thus, a high-quality dataset can be constructed without reducing the number of data. For example, by retaining both the data before correction and the data after correction, the number of data can be maintained while improving quality. Specifically, in Step 1, the input unit sequentially or in batch receives various data such as user-posted text, images, and audio, performs preprocessing for natural language processing and image/audio processing (e.g., tokenization, normalization, removal of unnecessary words, spectrogram conversion, image feature extraction), and formats them as input tensors for the generative AI (e.g., token ID sequences, pixel value arrays, audio spectrogram arrays). In Step 2, the detection unit uses a pre-trained large language model or multimodal model (e.g., Transformer-based autoregressive model, encoder-decoder model) to convert the input data into high-dimensional feature vectors through multi-layer self-attention mechanisms, and determines the presence or absence of inappropriate expressions for each token or sentence. The determination is output as binary labels (inappropriate/appropriate), multi-class classification (offensive, discriminatory, appropriate, etc.), or probability distributions (e.g., offensive 0.85, discriminatory 0.10, appropriate 0.05), and when a predetermined threshold is exceeded, the expression is judged as inappropriate, and the index and context information of the relevant part are passed to the correction unit. In Step 3, the correction unit uses algorithms such as partial generation (infill) or overall rewrite generation to automatically replace only the relevant part with neutral or gentle expressions while maintaining context. For example, “Your opinion is completely useless” is converted to “There are different perspectives on your opinion.” In Step 4, the corrected data is added to the original dataset as a new record by the addition unit and managed as paired data before and after correction. The addition unit attaches correction history and metadata (correction date, correction reason, detection score, etc.) in the database and utilizes them for subsequent selection of training data and quality management. As a technical effect, the system achieves significant improvement in processing speed and accuracy with consistent judgment criteria compared to manual visual checks and manual corrections, enabling large-scale data expansion and cleansing while maintaining dataset quality. Furthermore, the detection and correction algorithms realize context-dependent judgments that are difficult with rule-based methods by extracting features in high-dimensional vector spaces, and adopt computer-specific unconventional processing methods that differ from conventional simple NG word replacement or human intuitive judgment. Application fields include construction of training datasets for natural language processing, monitoring of SNS posts, automatic generation of FAQs, preparation of training data for customer support chatbots, and quality management of educational content. In these fields, the present invention exhibits remarkable technical effects such as homogenization and improvement of data quality, reduction of AI model bias, suppression of false detection and false correction, and reduction of operational costs.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned input unit, detection unit, correction unit, and addition unit is implemented, for example, in at least one of the smart device 14 and the data processing apparatus 12. For example, the input unit is implemented by a control unit 46A of the smart device 14 and inputs each data in the dataset to a generative AI. The detection unit is implemented, for example, by a specific processing unit 290 of the data processing apparatus 12 and detects inappropriate expressions using the generative AI. The correction unit is implemented, for example, by the specific processing unit 290 of the data processing apparatus 12 and corrects the detected inappropriate expressions to appropriate expressions. The addition unit is implemented, for example, by the control unit 46A of the smart device 14 and adds the corrected data to the original dataset. The correspondence between each unit and the apparatus or control unit is not limited to the above examples and various modifications are possible.

### [Second Embodiment]

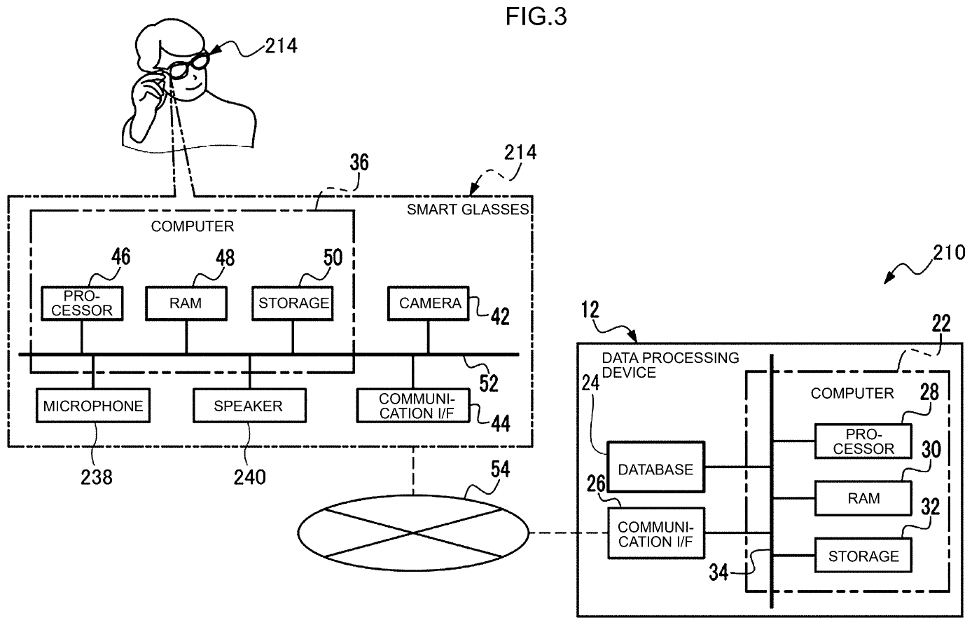

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

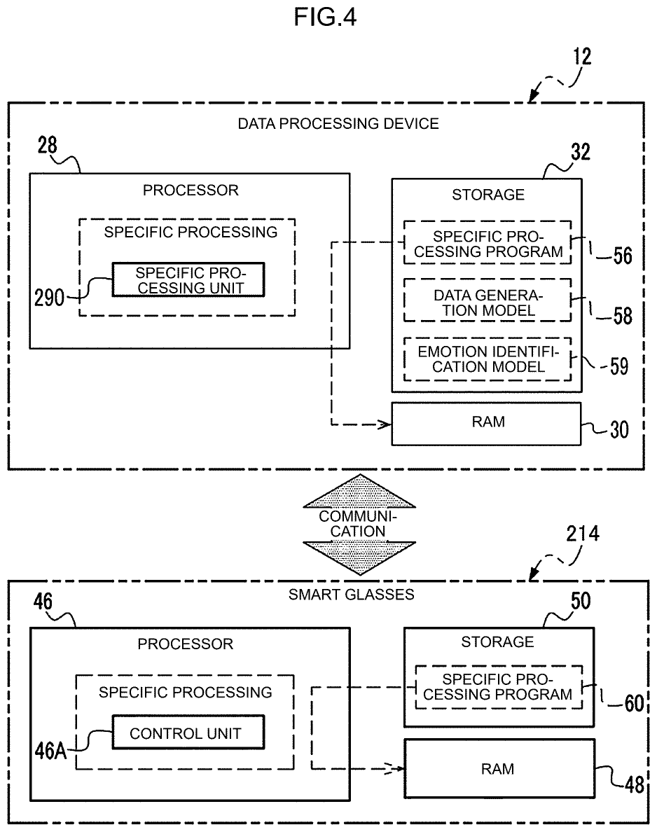

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned input unit, detection unit, correction unit, and addition unit is implemented, for example, in at least one of the smart glasses 214 and the data processing apparatus 12. For example, the input unit is implemented by a control unit 46A of the smart glasses 214 and inputs each data in the dataset to a generative AI. The detection unit is implemented, for example, by a specific processing unit 290 of the data processing apparatus 12 and detects inappropriate expressions using the generative AI. The correction unit is implemented, for example, by the specific processing unit 290 of the data processing apparatus 12 and corrects the detected inappropriate expressions to appropriate expressions. The addition unit is implemented, for example, by the control unit 46A of the smart glasses 214 and adds the corrected data to the original dataset. The correspondence between each unit and the apparatus or control unit is not limited to the above examples and various modifications are possible.

### [Third Embodiment]

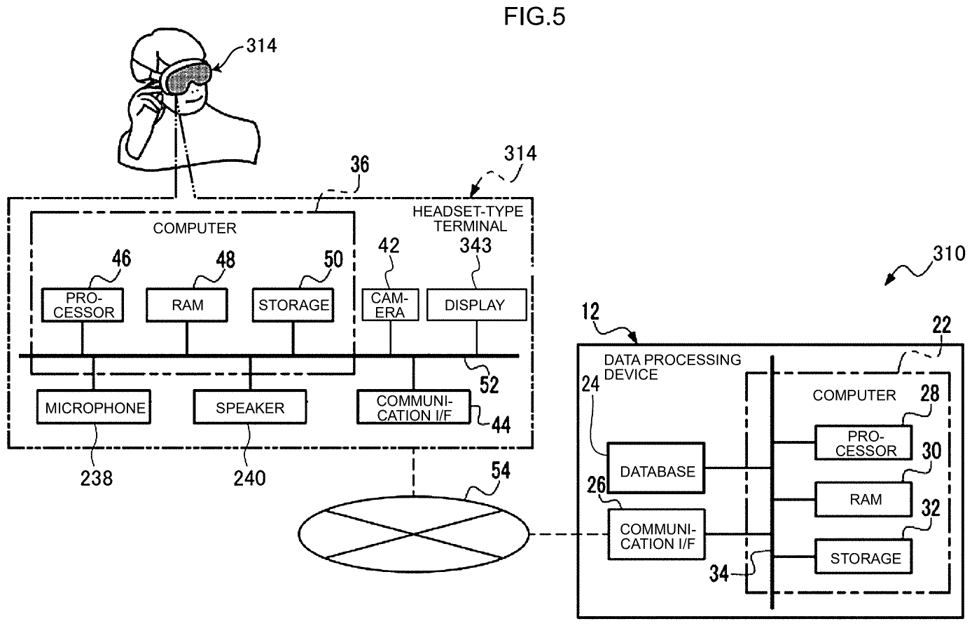

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

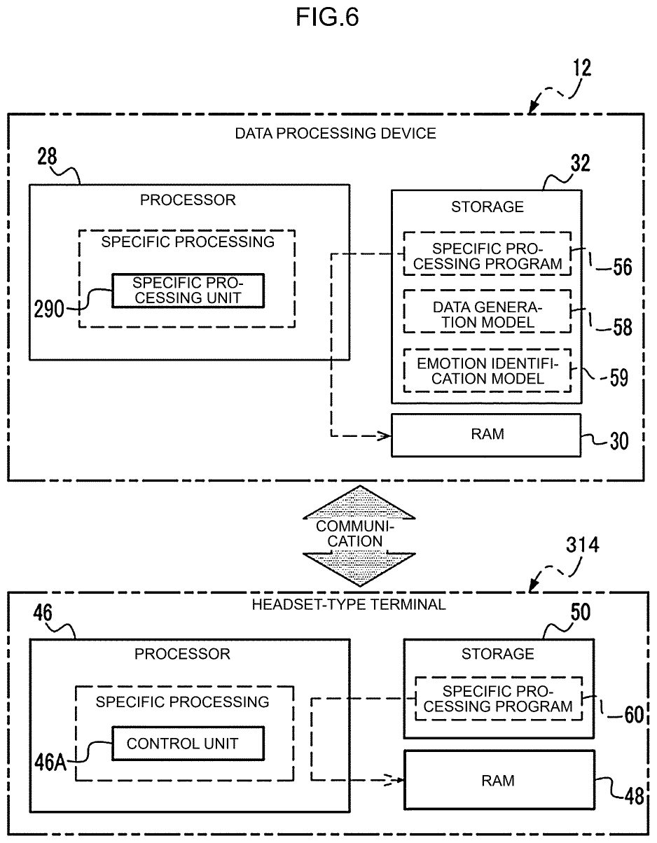

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned input unit, detection unit, correction unit, and addition unit is implemented, for example, in at least one of the headset-type terminal 314 and the data processing apparatus 12. For example, the input unit is implemented by a control unit 46A of the headset-type terminal 314 and inputs each data in the dataset to a generative AI. The detection unit is implemented, for example, by a specific processing unit 290 of the data processing apparatus 12 and detects inappropriate expressions using the generative AI. The correction unit is implemented, for example, by the specific processing unit 290 of the data processing apparatus 12 and corrects the detected inappropriate expressions to appropriate expressions. The addition unit is implemented, for example, by the control unit 46A of the headset-type terminal 314 and adds the corrected data to the original dataset. The correspondence between each unit and the apparatus or control unit is not limited to the above examples and various modifications are possible.

### [Fourth Embodiment]

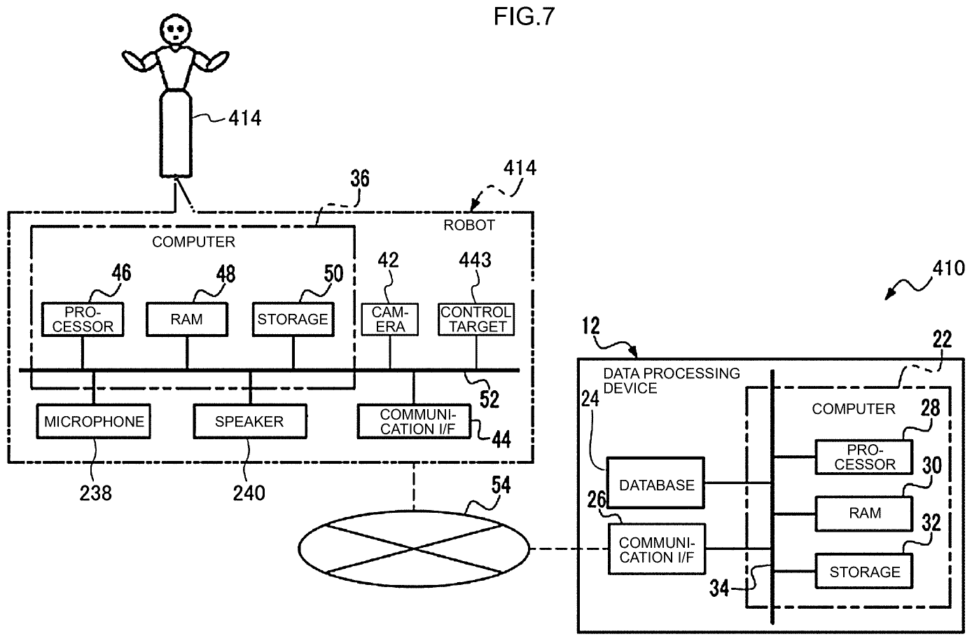

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

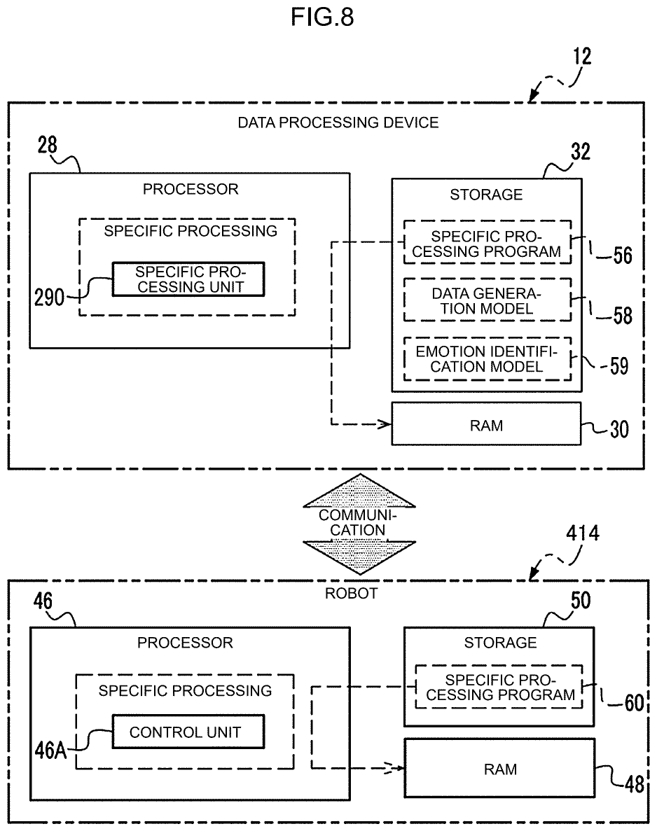

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned input unit, detection unit, correction unit, and addition unit is implemented, for example, in at least one of the robot 414 and the data processing apparatus 12. For example, the input unit is implemented by a control unit 46A of the robot 414 and inputs each data in the dataset to a generative AI. The detection unit is implemented, for example, by a specific processing unit 290 of the data processing apparatus 12 and detects inappropriate expressions using the generative AI. The correction unit is implemented, for example, by the specific processing unit 290 of the data processing apparatus 12 and corrects the detected inappropriate expressions to appropriate expressions. The addition unit is implemented, for example, by the control unit 46A of the robot 414 and adds the corrected data to the original dataset. The correspondence between each unit and the apparatus or control unit is not limited to the above examples and various modifications are possible.

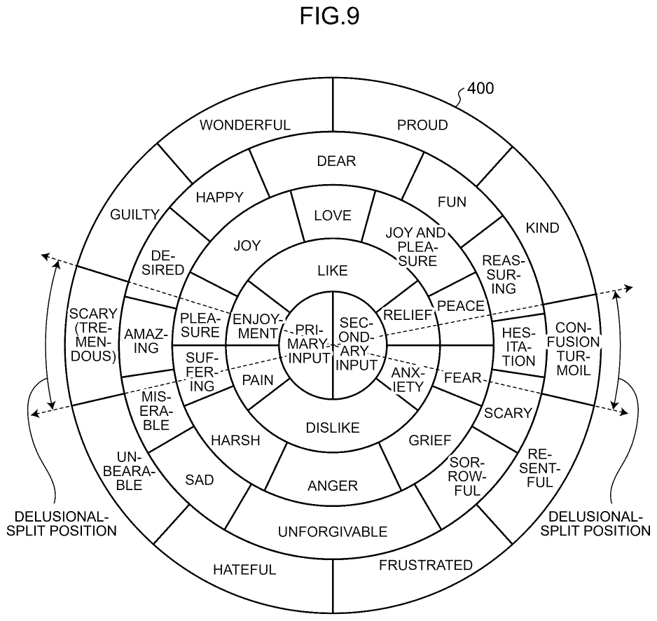

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac. jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

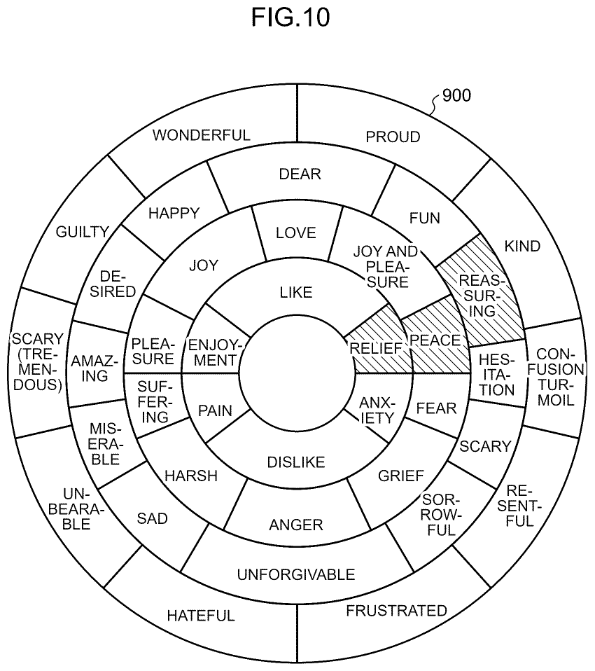

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Supplementary Note 1) A system comprising: an input unit configured to input each data in a dataset; a detection unit configured to analyze the data input by the input unit and detect inappropriate expressions; a correction unit configured to correct the inappropriate expressions detected by the detection unit to appropriate expressions; and an addition unit configured to add the data corrected by the correction unit to the original dataset.
(Supplementary Note 2) The system according to Supplementary Note 1, wherein the detection unit is configured to detect discriminatory expressions or offensive words as inappropriate expressions.
(Supplementary Note 3) The system according to Supplementary Note 1, wherein the correction unit is configured to correct discriminatory expressions to specific expressions.
(Supplementary Note 4) The system according to Supplementary Note 1, wherein the correction unit is configured to correct offensive words to specific words.
(Supplementary Note 5) The system according to Supplementary Note 1, wherein the addition unit is configured to retain both the data before correction and the data after correction.
(Supplementary Note 6) The system according to Supplementary Note 1, wherein the input unit is configured to estimate a user's emotion and specifically adjust the timing of data input based on the estimated user's emotion.
(Supplementary Note 7) The system according to Supplementary Note 1, wherein the input unit is configured to analyze a user's past posting history at the time of data input and select a specific input method.
(Supplementary Note 8) The system according to Supplementary Note 1, wherein the input unit is configured to perform filtering based on the user's current field of interest at the time of data input.
(Supplementary Note 9) The system according to Supplementary Note 1, wherein the input unit is configured to estimate a user's emotion and specifically determine the priority of data to be input based on the estimated user's emotion.
(Supplementary Note 10) The system according to Supplementary Note 1, wherein the input unit is configured to preferentially input highly relevant data by considering the user's geographic location information at the time of data input.
(Supplementary Note 11) The system according to Supplementary Note 1, wherein the input unit is configured to analyze a user's social media activity at the time of data input and input relevant data.
(Supplementary Note 12) The system according to Supplementary Note 1, wherein the detection unit is configured to estimate a user's emotion and specifically adjust the detection criteria for inappropriate expressions based on the estimated user's emotion.
(Supplementary Note 13) The system according to Supplementary Note 1, wherein the detection unit is configured to improve the detection accuracy of inappropriate expressions by considering the context of the data at the time of detection.
(Supplementary Note 14) The system according to Supplementary Note 1, wherein the detection unit is configured to detect inappropriate expressions by considering attribute information of the data poster at the time of detection.
(Supplementary Note 15) The system according to Supplementary Note 1, wherein the detection unit is configured to estimate a user's emotion and specifically adjust the display order of detection results based on the estimated user's emotion.
(Supplementary Note 16) The system according to Supplementary Note 1, wherein the detection unit is configured to detect inappropriate expressions by considering the geographic distribution of the data at the time of detection.
(Supplementary Note 17) The system according to Supplementary Note 1, wherein the detection unit is configured to improve the detection accuracy of inappropriate expressions by referring to related literature at the time of detection.
(Supplementary Note 18) The system according to Supplementary Note 1, wherein the correction unit is configured to estimate a user's emotion and specifically adjust the manner of correction based on the estimated user's emotion.
(Supplementary Note 19) The system according to Supplementary Note 1, wherein the correction unit is configured to adjust the level of detail of correction based on the importance of the data at the time of correction.
(Supplementary Note 20) The system according to Supplementary Note 1, wherein the correction unit is configured to apply different correction algorithms according to the category of the data at the time of correction.
(Supplementary Note 21) The system according to Supplementary Note 1, wherein the correction unit is configured to estimate a user's emotion and specifically adjust the length of correction based on the estimated user's emotion.
(Supplementary Note 22) The system according to Supplementary Note 1, wherein the correction unit is configured to determine the priority of correction based on the posting time of the data at the time of correction.
(Supplementary Note 23) The system according to Supplementary Note 1, wherein the correction unit is configured to adjust the order of correction based on the relevance of the data at the time of correction.
(Supplementary Note 24) The system according to Supplementary Note 1, wherein the addition unit is configured to estimate a user's emotion and specifically determine the priority of data to be added based on the estimated user's emotion.
(Supplementary Note 25) The system according to Supplementary Note 1, wherein the addition unit is configured to improve the accuracy of addition by considering the interrelationship of the data at the time of addition.
(Supplementary Note 26) The system according to Supplementary Note 1, wherein the addition unit is configured to perform addition by considering attribute information of the data poster at the time of addition.
(Supplementary Note 27) The system according to Supplementary Note 1, wherein the addition unit is configured to estimate a user's emotion and specifically adjust the display method of data to be added based on the estimated user's emotion.
(Supplementary Note 28) The system according to Supplementary Note 1, wherein the addition unit is configured to perform addition by considering the geographic distribution of the data at the time of addition.
(Supplementary Note 29) The system according to Supplementary Note 1, wherein the addition unit is configured to improve the accuracy of addition by referring to related literature at the time of addition.

What is claimed is:

1. A system comprising:
circuitry configured to:
receive input data from a dataset, the input data comprising text token sequences;
apply a trained classification model to the input data, the trained classification model comprising a Transformer-based neural network with multi-layer self-attention mechanisms, to generate a classification output indicating a presence or absence of a target expression pattern in the input data;
based on the classification output exceeding a predetermined threshold, generate corrected data by inputting the input data and the classification output into a data generation model that replaces the target expression pattern with a substitute expression while maintaining contextual coherence of the input data; and
add the corrected data to the dataset.

2. The system according to claim 1, wherein the classification output comprises a probability distribution over a plurality of expression categories, and the circuitry is configured to determine the target expression pattern is present when a probability value for at least one expression category exceeds the predetermined threshold.

3. The system according to claim 1, wherein the trained classification model generates the classification output at a token level or a sentence level within the input data.

4. The system according to claim 1, wherein the data generation model comprises a decoder of the Transformer-based neural network, and the circuitry is configured to generate the corrected data by partial generation that regenerates a portion of the input data corresponding to the target expression pattern while maintaining surrounding context, or by rewrite generation that regenerates an entirety of the input data.

5. The system according to claim 1, wherein the circuitry is further configured to add the corrected data to the dataset while retaining the input data before correction in the dataset, such that both the input data and the corrected data are stored as paired data.

6. The system according to claim 5, wherein the circuitry is further configured to attach metadata to the paired data, the metadata comprising at least one of a correction date, a reason for correction, or a classification score from the classification output.

7. The system according to claim 1, wherein the circuitry is further configured to:
collect multimodal data associated with a user, the multimodal data comprising at least one of text data, audio data, facial image data, or operation log data;
apply an emotion identification model to the multimodal data to generate an emotion estimation result comprising probability values for a plurality of emotion labels; and
adjust a processing parameter based on the emotion estimation result.

8. The system according to claim 7, wherein the processing parameter comprises the predetermined threshold, and the circuitry is configured to set a stricter threshold when a stress-related probability value exceeds a first value and to set a more permissive threshold when a relaxation-related probability value exceeds a second value.

9. The system according to claim 7, wherein the processing parameter comprises a timing of receiving the input data, and the circuitry is configured to delay receiving the input data when a stress-related probability value exceeds a first value and to accelerate receiving the input data when a relaxation-related probability value exceeds a second value.

10. The system according to claim 7, wherein the processing parameter comprises an expression style of the substitute expression, and the circuitry is configured to select a gentle expression template when a stress-related probability value exceeds a first value, a detailed expression template when a relaxation-related probability value exceeds a second value, or a concise expression template when an impatience-related probability value exceeds a third value.

11. The system according to claim 1, wherein the circuitry is further configured to apply a context understanding model to contextual information associated with the input data, the contextual information comprising at least one of preceding text, following text, conversation history, or a posting category, and to adjust the classification output based on the contextual information.

12. The system according to claim 1, wherein the circuitry is further configured to integrate attribute information of a data poster with the input data as input tensors for the trained classification model, the attribute information comprising at least one of age, gender, occupation, or residential area, and to adjust detection criteria for the target expression pattern based on the attribute information.

13. The system according to claim 1, wherein the circuitry is further configured to:
analyze a user behavioral history comprising at least one of browsing history, search queries, or interaction logs; and
calculate a relevance score between the input data and a field of interest derived from the user behavioral history, and filter the input data based on the relevance score exceeding a relevance threshold.

14. The system according to claim 1, wherein the circuitry is further configured to:
receive geographic location information associated with a user terminal; and
calculate a relevance score between the input data and the geographic location information, and preferentially process input data having a relevance score exceeding a location-based threshold.

15. The system according to claim 1, wherein the data generation model generates a plurality of correction candidates for the target expression pattern, and the circuitry is configured to automatically select a correction candidate that best matches a surrounding context of the input data.

16. The system according to claim 1, wherein the circuitry is further configured to adjust a level of detail of the corrected data based on an importance score assigned to the input data, the importance score being derived from at least one of a usage frequency, a number of references, or a user rating associated with the input data.

17. The system according to claim 1, wherein the circuitry is further configured to collect user feedback regarding the corrected data and to use the user feedback as at least one of additional training data for the data generation model or reward signals for reinforcement learning to optimize correction parameters.

18. A system comprising:
a communication interface comprising a communication processor and an antenna, the communication interface being connected to a packet-switched network;
a processor comprising at least one of a central processing unit, a graphics processing unit, or a tensor processing unit;
a random-access memory connected to the processor via a bus;
a non-volatile storage device storing a specific processing program, a trained classification model, and a data generation model; and
a database storing a dataset comprising text data,
wherein the processor is configured to execute the specific processing program on the random-access memory to:
receive, via the communication interface, input data from the dataset, the input data comprising text token sequences formatted as input tensors;
apply the trained classification model to the input data, the trained classification model comprising a Transformer-based neural network with multi-layer self-attention mechanisms that maps the input data into a high-dimensional feature vector space, to generate a classification output comprising a probability distribution over a plurality of expression categories at a token level or a sentence level;
based on a probability value in the classification output exceeding a predetermined threshold, generate corrected data by inputting the input data and the classification output into the data generation model, the data generation model comprising a decoder that replaces a target expression pattern with a substitute expression using at least one of partial generation or rewrite generation while maintaining contextual coherence; and
store the corrected data and the input data as paired data in the database together with metadata comprising a correction date and a classification score.

19. The system according to claim 18, wherein the processor is further configured to:
collect multimodal data associated with a user via the communication interface, the multimodal data comprising at least two of text data, audio data, facial image data, or operation log data;
preprocess the multimodal data by at least one of tokenization, spectrogram conversion, facial feature extraction, or time-series vectorization to generate integrated input tensors;
apply an emotion identification model stored in the non-volatile storage device to the integrated input tensors to generate an emotion estimation result comprising probability values for a plurality of emotion labels; and
adjust at least one of the predetermined threshold, a timing of receiving the input data, or an expression style of the substitute expression based on the emotion estimation result.

20. A method performed by circuitry of a system, the method comprising:
receiving input data from a dataset, the input data comprising text token sequences;
applying a trained classification model to the input data, the trained classification model comprising a Transformer-based neural network with multi-layer self-attention mechanisms, to generate a classification output indicating a presence or absence of a target expression pattern in the input data;
based on the classification output exceeding a predetermined threshold, generating corrected data by inputting the input data and the classification output into a data generation model that replaces the target expression pattern with a substitute expression while maintaining contextual coherence of the input data; and
adding the corrected data to the dataset.
